(19) United States
(12) Patent Application Publication
(10) Pub. No.: US 2010/0107172 A1
(43) Pub. Date: Apr. 29, 2010

(54) System providing methodology for policy-based resource allocation

(75) Inventors: Radu Calinescu, Oxford (GB); Jonathan M. D. Hill, Oxford (GB)

Correspondence Address: SPRINKLE IP LAW GROUP, 1301 W. 25TH STREET, SUITE 408, AUSTIN, TX, 78705, US

(73) Assignee: Sychron Advanced Technologies, Inc., Austin, TX (US)

(21) Appl. No.: 12/387,710

(22) Filed: May 6, 2009

Related U.S. Application Data
(62) Division of application No. 10/710,322, filed on Jul. 1, 2004.
(60) Provisional application No. 60/481,848, filed on Dec. 31, 2003.

(51) Int. Cl. G06F 15/173; G06F 9/46

(52) U.S. Cl. 718/104; 709/226; 718/105

(57) ABSTRACT

A system providing methodology for policy-based resource allocation is described. In one embodiment, for example, a system for allocating computer resources amongst a plurality of applications based on a policy is described that comprises: a plurality of computers connected to one another through a network; a policy engine for. specifying a policy for allocation of resources of the plurality of computers amongst a plurality of applications having access to the resources; a monitoring module at each computer for detecting demands for the resources and exchanging information regarding demands for the resources at the plurality of computers; and an enforcement module at each computer for allocating the resources amongst the plurality of applications based on the policy and information regarding demands for the resources.

### RELATED APPLICATIONS

The present application is a divisional application of U.S. patent application Ser. No. 10/710,322 (Docket No. SYCH1110-1), filed on Jul. 1, 2004, entitled “System Providing Methodology for Policy-Based Resource Allocation” which is related to and claims the benefit of priority of the following commonly-owned, presently-pending provisional application(s): application Ser. No. 60/481,848, filed Dec. 31, 2003, entitled “System Providing Methodology for Policy-Based Resource Allocation”. The present application is related to the following commonly-owned, presently-pending application(s): application Ser. No. 10/605,938 (Docket No. SYCH1100-1), filed Nov. 6, 2003, entitled “Distributed System Providing Scalable Methodology for Real-Time Control of Server Pools and Data Centers”. The disclosures of each of the foregoing applications are hereby incorporated by reference in their entirety, including any appendices or attachments thereof, for all purposes.

### COPYRIGHT STATEMENT

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### APPENDIX DATA

Computer Program Listing Appendix under Sec. 1.52(e): This application includes a transmittal under 37 C.F.R. Sec. 1.52(e) of a Computer Program Listing Appendix. The Appendix, which comprises a .pdf file that is IBM-PC machine and Microsoft Windows Operating System compatible, includes the below-listed file(s). All of the material disclosed in the Computer Program Listing Appendix can be found at the U.S. Patent and Trademark Office archives and is hereby incorporated by reference into the present application.

Object Description: SourceCode.pdf, created: Mar. 17, 2009, 4:23 pm, size 156 KB; Object ID: File No. 1; Object Contents: Source Code.

### BACKGROUND OF INVENTION

1. Field of the Invention

The present invention relates generally to information processing environments and, more particularly, to a system providing methodology for policy-based allocation of computing resources.

2. Description of the Background Art

A major problem facing many businesses today is the growing cost of providing information technology (IT) services. The source of one of the most costly problems is the administration of a multiple tier (n-tier) server architecture typically used today by businesses and other organizations, in which each tier conducts a specialized function as a component part of an IT service. In this type of multiple-tier environment, one tier might, for example, exist for the front-end Web server function, while another tier supports the mid-level applications such as shopping cart selection in an Internet electronic commerce (eCommerce) service. A back-end data tier might also exist for handling purchase transactions for customers. The advantages of this traditional multiple tier approach to organizing a data center are that the tiers provide dedicated bandwidth and CPU resources for each application. The tiers can also be isolated from each other by firewalls to control routable Internet Protocol traffic being forwarded inappropriately from one application to another.

There are, however, a number of problems in maintaining and managing all of these tiers in a data center. First, each tier is typically managed as a separate pool of servers which adds to the administrative overhead of managing the data center. Each tier also generally requires over-provisioned server and bandwidth resources (e.g., purchase of hardware with greater capacity than necessary based on anticipated demand) to maintain availability as well as to handle unanticipated user demand. Despite the fact that the cost of servers and bandwidth continues to fall, tiers are typically isolated from one another in silos, which makes sharing over-provisioned capacity difficult and leads to low resource utilization under normal conditions. For example, one “silo” (e.g., a particular server) may, on average, be utilizing only twenty percent of its CPU capacity. It would be advantageous to harness this surplus capacity and apply it to other tasks.

Currently, the overall allocation of server resources to applications is performed by separately configuring and reconfiguring each required resource in the data center. In particular, server resources for each application are managed separately. The configuration of other components that link the servers together such as traffic shapers, load balancers, and the like, is also separately managed in most cases. In addition, re-configuration of each one of these separately managed components is also typically performed without any direct linkage to the business goals of the configuration change.

Many server vendors are promoting the replacement of multiple small servers with fewer, larger servers as a solution to the problem of server over-provisioning. This approach alleviates some of these administration headaches by replacing the set of separately managed servers with either a single server or a smaller number of servers. However, it does not provide any relief for application management since each one still needs to be isolated from the others using either hardware or software boundaries to prevent one application consuming more than its appropriate share of the resources.

Hardware boundaries (also referred to by some vendors as “dynamic system domains”) allow a server to run multiple operating system (OS) images simultaneously by partitioning the server into logically distinct resource domains at the granularity of the CPU, memory, and Input/Output cards. With this dynamic system domain solution, however, it is difficult to dynamically move CPU resources between domains without, for example, also moving some Input/Output ports. This type of resource reconfiguration typically must be performed manually by the system administrator. This is problematic as manual configuration is inefficient and also does not facilitate making dynamic adjustments to resource allocations based on changing demand for resources.

Existing software boundary mechanisms allow resources to be re-configured more dynamically than hardware boundaries. However, current software boundary mechanisms apply only to the resources of a single server. Consequently, a data center which contains many servers still has the problem of managing the resource requirements of applications running across multiple servers, and of balancing the workload between them.

Today, if a business goal is to provide a particular application with a certain priority for resources so that it can sustain a required level of service to users, then the only controls available to the administrator to affect this change are focused on the resources rather than on the application. For example, to allow a particular application to deliver faster response time, adjusting a traffic shaper to permit more of the application's traffic type on the network may not necessarily result in the desired level of service. The bottleneck may not be bandwidth-related; instead it may be that additional CPU resources are also required. As another example, the performance problem may result from the behavior of another program in the data center which generates the same traffic type as the priority application. Improving performance may require constraining resource usage by this other program.

More generally, utilization of one type of resource may affect the data center's ability to deliver a different type of resource to the applications and users requiring the resources. For instance, if CPU resources are not available to service the requirements of an application, it may be impossible to meet the network bandwidth requirements of this application and, ultimately, to satisfy the users of the application. In this type of environment, allocation of resources amongst applications must take into account a number of different factors, including availability of various types of resources and interdependencies amongst such resources. Moreover, the allocation of resources must take into account changing demand for resources as well as changing resource availability.

Current solutions for allocating data center resources generally apply broad, high-level rules. However, these broad, high-level rules generally cannot take into account the wide variety of factors that are relevant to determining appropriate resource allocation. In addition, both demand for resources and resource availability are subject to frequent changes in the typical data center environment. Current solutions also have difficulty in responding rapidly and flexibly to these frequently changing conditions. As a result, current solutions only provide limited capabilities for optimizing resource utilization and satisfying service level requirements.

A solution is needed that continuously distributes resources to applications based on the flexible application of business policies and service level requirements to dynamically changing conditions. In distributing resources to applications, the solution should be able to examine multiple classes of resources and their interdependencies, and apply fine-grained policies for resource allocation. Ideally, it should enable a user to construct and apply resource allocation policies that are as simple or as complex as required to achieve the user's business goals. The solution should also be distributed and scalable, allowing even the largest data centers with various applications having fluctuating demands for resources to be automatically controlled. The present invention provides a solution for these and other needs.

### SUMMARY OF INVENTION

A system providing methodology for policy-based resource allocation is described. In one embodiment, for example, a system of the present invention for allocating resources amongst a plurality of applications is described that comprises: a plurality of computers connected to one another through a network; a policy engine for specifying a policy for allocation of resources of the plurality of computers amongst a plurality of applications having access to the resources; a monitoring module at each computer for detecting demands for the resources and exchanging information regarding demands for the resources at the plurality of computers; and an enforcement module at each computer for allocating the resources amongst the plurality of applications based on the policy and information regarding demands for the resources.

In another embodiment, for example, an improved method of the present invention is described for allocating resources of a plurality of computers to a plurality of applications, the method comprises steps of: receiving user input for dynamically configuring a policy for allocating resources of a plurality of computers amongst a plurality of applications having access to the resources; at each of the plurality of computers, detecting demands for the resources from the plurality of applications and availability of the resources; exchanging information regarding demand for the resources and availability of the resources amongst the plurality of computers; and allocating the resources to each of the plurality of applications based on the policy and the information regarding demand for the resources and availability of the resources.

In yet another embodiment, for example, a method of the present invention is described for allocating resources to a plurality of applications, the method comprises steps of: receiving user input specifying priorities of the plurality of applications to resources of a plurality of servers, the specified priorities including designated servers assigned to at least some of the plurality of applications; selecting a given application based upon the specified priorities of the plurality of applications; determining available servers on which the given application is runable and which are not assigned to a higher priority application; allocating to the given application any available servers which are designated servers assigned to the given application; allocating any additional available servers to the given application until the given application's demands for resources are satisfied; and repeating above steps for each of the plurality of applications based on the specified priorities.

### BRIEF DESCRIPTION OF DRAWINGS

FIG. 1 is a very general block diagram of a computer system in which software-implemented processes of the present invention may be embodied.

FIG. 2 is a block diagram of a software system for controlling the operation of the computer system.

FIG. 3 is a high-level block diagram illustrating an environment in which the system of the present invention is preferably embodied.

FIG. 4 is a block diagram illustrating an environment demonstrating the interaction between the system of the present invention and a third party component.

FIGS. 5A-B comprise a single flowchart describing at a high-level the scheduling methodology used to allocate servers to applications in the currently preferred embodiment of the system.

FIGS. 6A-B comprise a single flowchart illustrating an example of the system of the present invention applying application policies to allocate resources amongst two applications.

### DETAILED DESCRIPTION

### Glossary

The following definitions are offered for purposes of illustration, not limitation, in order to assist with understanding the discussion that follows.

Burst capacity: The burst capacity or “headroom” of a program (e.g., an application program) is a measure of the extra resources (i.e., resources beyond those specified in the resource policy) that may potentially be available to the program should the extra resources be idle. The headroom of an application is a good indication of how well it may be able to cope with sudden spikes in demand. For example, an application running on a single server whose policy guarantees that 80% of the CPU resources are allocated to this application has 20% headroom. However, a similar application running on two identical servers whose policy guarantees it 40% of the resources of each CPU has headroom of 120% of the CPU resources of one server (i.e., 2×60%).

CORBA: CORBA refers to the Object Management Group (OMG) Common Object Request Broker Architecture which enables program components or objects to communicate with one another regardless of what programming language they are written in or what operating system they are running on. CORBA is an architecture and infrastructure that developers may use to create computer applications that work together over networks. A CORBA-based program from one vendor can interoperate with a CORBA-based program from the same or another vendor, on a wide variety of computers, operating systems, programming languages, and networks. For further description of CORBA, see e.g., “Common Object Request Broker Architecture: Core Specification, Version 3.0” (December 2002), available from the OMG, the disclosure of which is hereby incorporated by reference.

Flow: A flow is a subset of network traffic which usually corresponds to a stream (e.g., Transmission Control Protocol/Internet Protocol or TCP/IP), connectionless traffic (User Datagram Protocol/Internet Protocol or UDP/IP), or a group of such connections or patterns identified over time. A flow consumes the resources of one or more pipes.

J2EE: This is an abbreviation for Java 2 Platform Enterprise Edition, which is a platform-independent, Java-centric environment from Sun Microsystems for developing, building and deploying Web-based enterprise applications. The J2EE platform consists of a set of services, APIs, and protocols that provide functionality for developing multitiered, web-based applications. For further information on J2EE, see e.g., “Java 2 Platform, Enterprise Edition Specification, version 1.4”, from Sun Microsystems, Inc., the disclosure of which is hereby incorporated by reference. A copy of this specification is available via the Internet (e.g., currently at java.sun.com/j2ee/docs.html).

Java: Java is a general purpose programming language developed by Sun Microsystems. Java is an object-oriented language similar to C++, but simplified to eliminate language features that cause common programming errors. Java source code files (files with a .java extension) are compiled into a format called bytecode (files with a .class extension), which can then be executed by a java interpreter. Compiled java code can run on most computers because java interpreters and runtime environments, known as java virtual machines (VMs), exist for most operating systems, including UNIX, the Macintosh OS, and Windows. Bytecode can also be converted directly into machine language instructions by a just-in-time UIT) compiler. Further description of the java Language environment can be found in the technical, trade, and patent literature; see e.g., Gosling, J. et al., “The java Language Environment: A White Paper,” Sun Microsystems Computer Company, October 1995, the disclosure of which is hereby incorporated by reference. For additional information on the java programming language (e.g., version 2), see e.g., “java 2 SDK, Standard Edition Documentation, version 1.4.2,” from Sun Microsystems, the disclosure of which is hereby incorporated by reference. A copy of this documentation is available via the Internet (e.g., currently at java.sun.com/j2se/1.4.2/docs/index.html).

JMX: The Java Management Extensions UMX) technology is an open technology for management and monitoring available from Sun Microsystems. A “Managed Bean”, or “MBean”, is the instrumentation of a resource in compliance with jMX specification design patterns. If the resource itself is a java application, it can be its own MBean; otherwise, an MBean is a java wrapper for native resources or a java representation of a device. MBeans can be distant from the managed resource, as long as they accurately represent its attributes and operations. For further description of JMX, see e.g., “jSR-000003 java Management Extensions UMX) vl.2 Specification”, from Sun Microsystems, the disclosure of which is hereby incorporated by reference. A copy of this specification is available via the Internet (e.g., currently at jcp.org/aboutjava/communityprocess/final/jsr003/index3.html).

Network: A network is a group of two or more systems linked together. There are many types of computer networks, including local area networks (LANs), virtual private networks (VPNs), metropolitan area networks (MANs), campus area networks (CANs), and wide area networks (WANs) including the Internet. As used herein, the term “network” refers broadly to any group of two or more computer systems or devices that are linked together from time to time (or permanently).

Pipe: A pipe is a shared network path for network (e.g., Internet Protocol) traffic which supplies inbound and outbound network bandwidth. Pipes are typically shared by all servers in a server pool, and are typically defined by the set of remote IP (i.e., Internet Protocol) addresses that the servers in the server pool can access by means of the pipe. It should be noted that in this document the term “pipes” refers to a network communication channel and should be distinguished from the UNIX concept of pipes for sending data to a particular program (e.g., a command line symbol meaning that the standard output of the command to the left of the pipe gets sent as standard input of the command to the right of the pipe).

Policy: A policy represents a formal description of the desired behavior of a system (e.g., a server pool), identified by a set of condition-action pairs. For instance, a policy may specify the server pool (computer) resources which are to be delivered to particular programs (e.g., applications or application instances) given a certain load pattern for the application. Also, the policy may specify that a certain command needs to be executed when certain conditions are met within the server pool.

RPC: RPC stands for remote procedure call, a type of protocol that allows a program on one computer (e.g., a client) to execute a program on another computer (e.g., a server). Using RPC, a system developer need not develop specific procedures for the server. The client program sends a message to the server with appropriate arguments and the server returns a message containing the results of the program executed. For further description of RPC, see e.g., RFC 1831 titled “RPC: Remote Procedure Call Protocol Specification Version 2”, available from the Internet Engineering Task Force (IETF), the disclosure of which is hereby incorporated by reference. A copy of RFC 1831 is available via the Internet (e.g., currently at www.ieff.org/rfc/rfc1831.txt).

Server pool: A server pool is a collection of one or more servers and a collection of one or more pipes. A server pool aggregates the resources supplied by one or more servers. A server is a physical machine which supplies CPU and memory resources. Computing resources of the server pool are consumed by one or more programs (e.g., applications) which run in the server pool. A server pool may have access to external resources such as load balancers, routers, and provisioning devices

TCP: TCP stands for Transmission Control Protocol. TCP is one of the main protocols in TCP/IP networks. Whereas the IP protocol deals only with packets, TCP enables two hosts to establish a connection and exchange streams of data. TCP guarantees delivery of data and also guarantees that packets will be delivered in the same order in which they were sent. For an introduction to TCP, see e.g., “RFC 793: Transmission Control Program DARPA Internet Program Protocol Specification”, the disclosure of which is hereby incorporated by reference. A copy of RFC 793 is available via the Internet (e.g., currently at www.ietf.org/rfc/rfc793.txt).

TCP/IP: TCP/IP stands for Transmission Control Protocol/Internet Protocol, the suite of communications protocols used to connect hosts on the Internet. TCP/IP uses several protocols, the two main ones being TCP and IP. TCP/IP is built into the UNIX operating system and is used by the Internet, making it the de facto standard for transmitting data over networks. For an introduction to TCP/IP, see e.g., “RFC 1180: A TCP/IP Tutorial”, the disclosure of which is hereby incorporated by reference. A copy of RFC 1180 is available via the Internet (e.g., currently at www.ietf.org/rfc/rfc1180.txt).

XML: XML stands for Extensible Markup Language, a specification developed by the World Wide Web Consortium (W3C). XML is a pared-down version of the Standard Generalized Markup Language (SGML), a system for organizing and tagging elements of a document. XML is designed especially for Web documents. It allows designers to create their own customized tags, enabling the definition, transmission, validation, and interpretation of data between applications and between organizations. For further description of XML, see e.g., “Extensible Markup Language (XML) 1.0”, (2nd Edition, Oct. 6, 2000) a recommended specification from the W3C, the disclosure of which is hereby incorporated by reference. A copy of this specification is available via the Internet (e.g., currently at www.w3.org/TR/REC-xml).

Referring to the figures, exemplary embodiments of the invention will now be described. The following description will focus on the presently preferred embodiment of the present invention, which is implemented in desktop and/or server software (e.g., driver, application, or the like) operating in an Internet-connected environment running under an operating system, such as the Microsoft Windows operating system. The present invention, however, is not limited to anyone particular application or any particular environment. Instead, those skilled in the art will find that the system and methods of the present invention may be advantageously embodied on a variety of different platforms, including Macintosh, Linux, Solaris, UNIX, FreeBSD, and the like. Therefore, the description of the exemplary embodiments that follows is for purposes of illustration and not limitation. The exemplary embodiments are primarily described with reference to block diagrams or flowcharts. As to the flowcharts, each block within the flowcharts represents both a method step and an apparatus element for performing the method step. Depending upon the implementation, the corresponding apparatus element may be configured in hardware, software, firmware or combinations thereof.

### Computer-Based Implementation

Basic System Hardware (e.g., For Desktop and Server Computers)

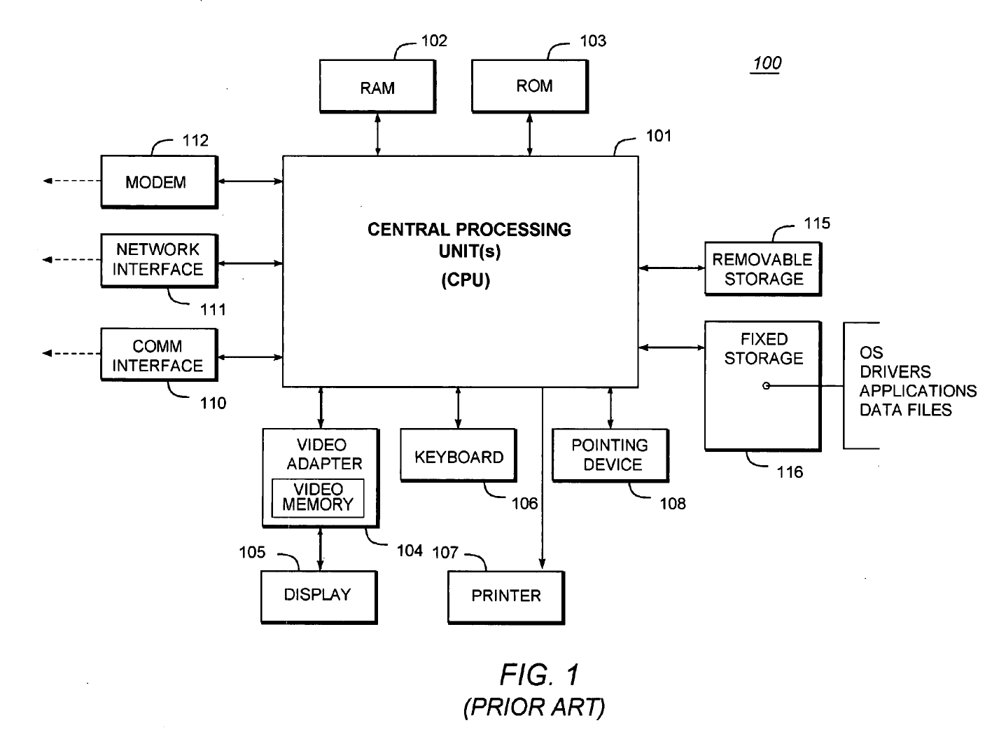

The present invention may be implemented on a conventional or general-purpose computer system, such as an IBM-compatible personal computer (PC) or server computer. FIG. 1 is a very general block diagram of a computer system (e.g., an IBM-compatible system) in which software-implemented processes of the present invention may be embodied. As shown, system 100 comprises a central processing unit(s) (CPU) or processor(s) 101 coupled to a random-access memory (RAM) 102, a read-only memory (ROM) 103, a keyboard 106, a printer 107, a pointing device 108, a display or video adapter 104 connected to a display device 105, a removable (mass) storage device 115 (e.g., floppy disk, CD-ROM, CD-R, CD-RW, DVD, or the like), a fixed (mass) storage device 116 (e.g., hard disk), a communication (COMM) port(s) or interface(s) 110, a modem 112, and a network interface card (NIC) or controller 111 (e.g., Ethernet). Although not shown separately, a real time system clock is included with the system 100, in a conventional manner.

CPU 101 comprises a processor of the Intel Pentium family of microprocessors. However, any other suitable processor may be utilized for implementing the present invention. The CPU 101 communicates with other components of the system via a bi-directional system bus (including any necessary input/output (I/O) controller circuitry and other “glue” logic). The bus, which includes address lines for addressing system memory, provides data transfer between and among the various components. Description of Pentium-class microprocessors and their instruction set, bus architecture, and control lines is available from Intel Corporation of Santa Clara, Calif. Random-access memory 102 serves as the working memory for the CPU 101. In a typical configuration, RAM of sixty-four megabytes or more is employed. More or less memory may be used without departing from the scope of the present invention. The read-only memory (ROM) 103 contains the basic input/output system code (BIOS)—a set of low-level routines in the ROM that application programs and the operating systems can use to interact with the hardware, including reading characters from the keyboard, outputting characters to printers, and so forth.

Mass storage devices 115, 116 provide persistent storage on fixed and removable media, such as magnetic, optical or magnetic-optical storage systems, flash memory, or any other available mass storage technology. The mass storage may be shared on a network, or it may be a dedicated mass storage. As shown in FIG. 1, fixed storage 116 stores a body of program and data for directing operation of the computer system, including an operating system, user application programs, driver and other support files, as well as other data files of all sorts. Typically, the fixed storage 116 serves as the main hard disk for the system.

In basic operation, program logic (including that which implements methodology of the present invention described below) is loaded from the removable storage 115 or fixed storage 116 into the main (RAM) memory 102, for execution by the CPU 101. During operation of the program logic, the system 100 accepts user input from a keyboard 106 and pointing device 108, as well as speech-based input from a voice recognition system (not shown). The keyboard 106 permits selection of application programs, entry of keyboard-based input or data, and selection and manipulation of individual data objects displayed on the screen or display device 105. Likewise, the pointing device 108, such as a mouse, track ball, pen device, or the like, permits selection and manipulation of objects on the display device. In this manner, these input devices support manual user input for any process running on the system.

The computer system 100 displays text and/or graphic images and other data on the display device 105. The video adapter 104, which is interposed between the display 105 and the system's bus, drives the display device 105. The video adapter 104, which includes video memory accessible to the CPU 101, provides circuitry that converts pixel data stored in the video memory to a raster signal suitable for use by a cathode ray tube (CRT) raster or liquid crystal display (LCD) monitor. A hard copy of the displayed information, or other information within the system 100, may be obtained from the printer 107, or other output device. Printer 107 may include, for instance, an HP LaserJet printer (available from Hewlett Packard of Palo Alto, Calif.), for creating hard copy images of output of the system.

The system itself communicates with other devices (e.g., other computers) via the network interface card (NIC) 111 connected to a network (e.g., Ethernet network, Bluetooth wireless network, or the like), and/or modem 112 (e.g., 56K baud, ISDN, DSL, or cable modem), examples of which are available from 3Com of Santa Clara, Calif. The system 100 may also communicate with local occasionally-connected devices (e.g., serial cable-linked devices) via the communication (COMM) interface 110, which may include a RS-232 serial port, a Universal Serial Bus (USB) interface, or the like. Devices that will be commonly connected locally to the interface 110 include laptop computers, handheld organizers, digital cameras, and the like.

IBM-compatible personal computers and server computers are available from a variety of vendors. Representative vendors include Dell Computers of Round Rock, Tex., Hewlett-Packard of Palo Alto, Calif., and IBM of Armonk, N.Y. Other suitable computers include Apple-compatible computers (e.g., Macintosh), which are available from Apple Computer of Cupertino, Calif., and Sun Solaris workstations, which are available from Sun Microsystems of Mountain View, Calif.

Basic System Software

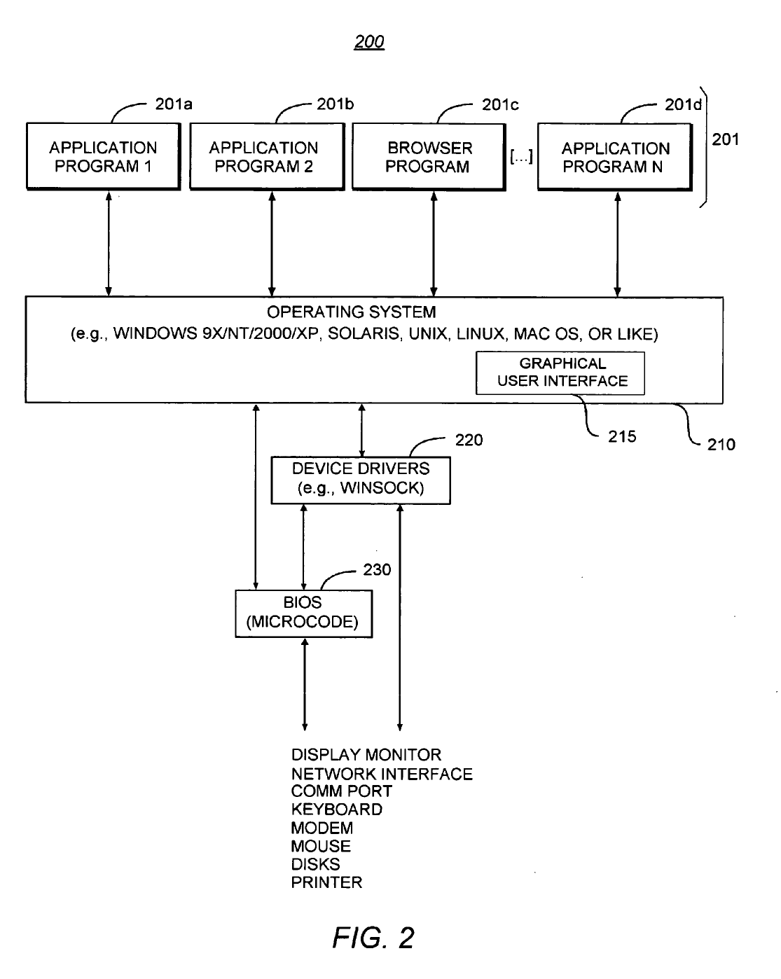

FIG. 2 is a block diagram of a software system for controlling the operation of the computer system 100. As shown, a computer software system 200 is provided for directing the operation of the computer system 100. Software system 200, which is stored in system memory (RAM) 102 and on fixed storage (e.g., hard disk) 116, includes a kernel or operating system (OS) 210. The OS 210 manages low-level aspects of computer operation, including managing execution of processes, memory allocation, file input and output (I/O), and device I/O. One or more application programs, such as client application software or “programs” 201 (e.g., 201a, 201b, 201c, 201d) may be “loaded” (i.e., transferred from fixed storage 116 into memory 102) for execution by the system 100. The applications or other software intended for use on the computer system 100 may also be stored as a set of downloadable computer-executable instructions, for example, for downloading and installation from an Internet location (e.g., Web server).

Software system 200 includes a graphical user interface (GUI) 215, for receiving user commands and data in a graphical (e.g., “point-and-click”) fashion. These inputs, in turn, may be acted upon by the system 100 in accordance with instructions from operating system 210, and/or client application module(s) 201. The GUI 215 also serves to display the results of operation from the as 210 and application(s) 201, whereupon the user may supply additional inputs or terminate the session. Typically, the as 210 operates in conjunction with device drivers 220 (e.g., “Winsock” driver—Windows' implementation of a TCP/IP stack) and the system BIOS microcode 230 (i.e., ROM-based microcode), particularly when interfacing with peripheral devices. as 210 can be provided by a conventional operating system, such as Microsoft Windows 9x, Microsoft Windows NT, Microsoft Windows 2000, or Microsoft Windows XP, all available from Microsoft Corporation of Redmond, Wash. Alternatively, as 210 can also be an alternative operating system, such as the previously mentioned operating systems.

The above-described computer hardware and software are presented for purposes of illustrating the basic underlying desktop and server computer components that may be employed for implementing the present invention. For purposes of discussion, the following description will present examples in which it will be assumed that there exists a server pool (i.e., group of servers) that communicate with each other and provide services and resources to applications running on the server pool and/or one or more “clients” (e.g., desktop computers). The present invention, however, is not limited to any particular environment or device configuration. In particular, a client/server distinction is not necessary to the invention, but is used to provide a framework for discussion. Instead, the present invention may be implemented in any type of system architecture or processing environment capable of supporting the methodologies of the present invention presented in detail below.

### Overview of System For Policy-Based Resource Allocation

The present invention comprises a system providing methodology for prioritizing and regulating the allocation of system resources to applications based upon resource policies. The system includes a policy engine providing policy-based mechanisms for adjusting the allocation of resources amongst applications running in a distributed, multi-processor computing environment. The system takes input from a variety of monitoring sources which describe aspects of the state and performance of applications running in the computing environment as well as the underlying resources (e.g., computer servers) which are servicing the applications. Based on this information, the policy engine evaluates and applies scripted policies which specify the actions that should be taken (if any) for allocating the resources of the system to the applications. For example, if resources serving a particular application are determined to be idle, the appropriate action may be for the application to relinquish all or a portion of the idle resources so that they may be utilized by other applications.

The actions that may be automatically taken may include (but are not limited to) one or more of the following: increasing or decreasing the number of servers associated with an application; increasing or decreasing the CPU shares allocated to an application; increasing or decreasing the bandwidth allocated to an application; performing load balancer adjustments; executing a user-specified command (i.e., program); and powering down an idle server. A variety of actions that might otherwise be taken manually in current systems (e.g., in response to changing demand for resources or other conditions) are handled automatically by the system of the present invention. The system of the present invention can be used to control a number of different types of resources including (but not limited to): processing resources (CPU), memory, communications resources (e.g., network bandwidth), disk space, system I/O (input/output), printers, tape drivers, load balancers, routers (e.g., to control bandwidth), provisioning devices (e.g., external servers running specialized software), or software licenses. Practically any resource that can be expressed as a quantity can be controlled using the system and methodology of the present invention.

The present invention provides a bridge between an organization's high-level business goals (or policies) for the operation of its data center and the reality of the low-level physical infrastructure of the data center. The low-level physical infrastructure of a typical data center includes a wide range of different components interacting with each other. A typical data center also supports a number of different applications. The system of the present invention monitors applications running in the data center as well as the resources serving such applications and allows the user to define policies which are then enforced to allocate resources intelligently and automatically.

The system's policy engine provides for application of a wide range of scripted policies specifying actions to be taken in particular circumstances. The policy engine examines a number of factors (e.g., resource availability and resource demands by applications) and their interdependencies and then applies fine-grained policies for allocation of resources. A user can construct and apply policies that can be simple or quite complex. The system can be controlled and configured by a user via a graphical user interface (which can connect remotely to any of the servers) or via a command line interface (which can be executed on any of the servers in the server pool, or on an external server connected remotely to any of the servers in the server pool). The solution is distributed and scalable, allowing even the largest data centers with various applications having fluctuating demands for resources to be automatically regulated and controlled.

The term “policy” has been used before in conjunction with computer systems and applications, however in a different context and for a different purpose. A good example is the Web Services Policy Framework (WS-Policy) jointly proposed by BEA, IBM, Microsoft, and SAP. This WS-Policy framework defines policies as sets of assertions specifying the preferences, requirements, or capabilities of a given subject. Unlike the policy-based resource allocation methodology of the present invention, the WS-Policy framework is restricted to a single class of systems (i.e., XML Web Services-based systems). Most importantly, the WS-Policy is capable of expressing only static characteristics of the policy subject, which allows only one-off decision making. In contrast, the policy mechanism provided by the present invention is dynamic, with the policy engine automatically adapting its actions to changes in the behavior of the managed system.

### System Components

The system of the present invention, in its currently preferred embodiment, is a fully distributed software system (or agent) that executes on each server in a server pool. The distributed nature of the system enables it to perform a brokerage function between resources and application demands by monitoring the available resources and matching them to the application resource demands. The system can then apply the aggregated knowledge about demand and resource availability at each server to permit resources to be allocated to each application based upon established policies, even during times of excessive demand. The architecture of the system will now be described.

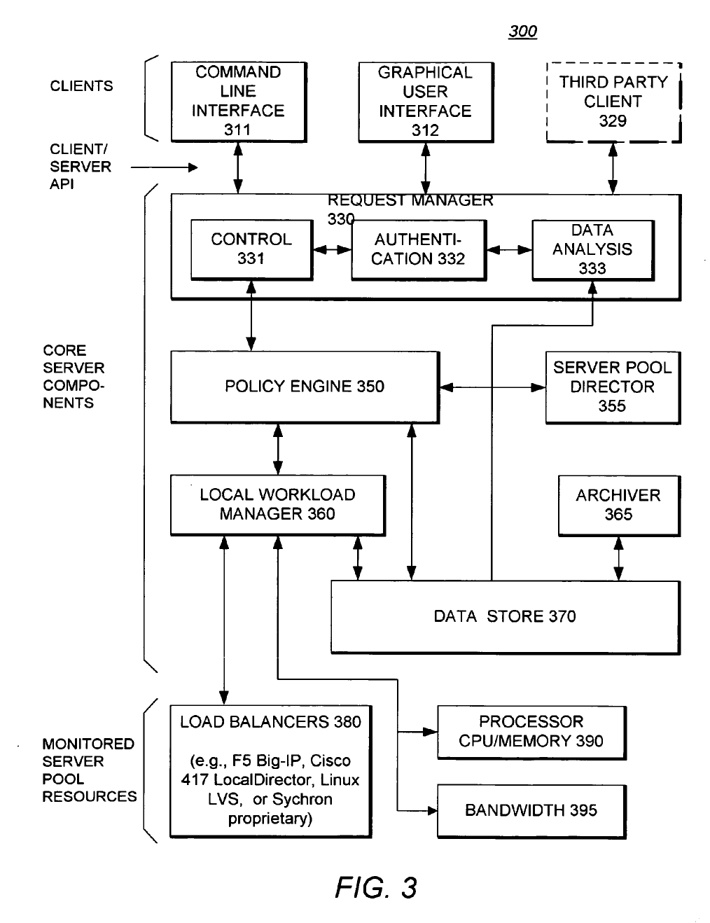

FIG. 3 is a high-level block diagram illustrating an environment 300 in which the system of the present invention is preferably embodied. As shown, the environment 300 includes a command line interface client 311, a graphical user interface (GUI) client 312, and an (optional) third party client 329, all of which are connected to a request manager 330. The server components include the request manager 330, a policy engine 350, a server pool director 355, a local workload manager 360, an archiver 365 and a data store 370. In the currently preferred embodiment, these server components run on every server in the pool. The policy engine 350, the server pool director 355, and the data store 370 are core modules implementing the policy-based resource allocation mechanisms of the present invention. The other server components include a number of separate modules for locally controlling and/or monitoring specific types of resources. Several of the monitored and controlled server pool resources are also shown at FIG. 3. These server pool resources include load balancers 380, processor (CPU) and memory resources 390, and bandwidth 395.

The clients include both the command line interface 311 and the GUI 312. Either of these interfaces can be used to query the server pool about applications and resources (e.g., servers) as well as to establish policies and perform various other actions. Information about the monitored and/or controlled resources is available in various forms at the application, application instance, server pool, and server level. In addition to these types of client interfaces (command line interface 311 and GUI 312), the system of the present invention includes a public API (application programming interface) that allows third parties to implement their own clients. As shown at FIG. 3, a third party client 329 may also be implemented to interface with the system of the present invention.

The request manager 330 is a server component that communicates with the clients. The request manager 330 receives client requests that may include requests for information recorded by the system's data store 370, and requests for changes in the policies enforced by the policy engine 350 (i.e., “control” requests). The data analysis sub-component 333 of the request manager 330 handles the first type of request (i.e., a request for information) by obtaining the necessary information from the data store 370, preprocessing the information as required, and then returning the result to the client. The second type of request (i.e., a request for changes in policies) is forwarded by the control sub-component 331 to the policy engine 350. The authentication sub-component 332 authenticates clients before the request manager 330 considers any type of request from the client.

The policy engine 350 is a fully distributed component that handles policy change requests received from clients, records these requests in the data store 370, and makes any necessary decisions about actions to be taken based on these requests. Also, the policy engine 350 includes a global scheduler (not separately shown at FIG. 3) that uses the global state of the server pool recorded in the data store and the latest policies configured by the user to determine the allocation of resources to applications, the power management of servers, and other actions to be taken in order to implement the policies. The decisions made by the policy engine 350 are recorded in the data store 370 for later implementation by the local workload manager(s) 360 running on the appropriate servers, and/or the decisions may be forwarded directly to the local workload manager(s) 360 for immediate implementation.

The server pool director 355 is a fully distributed component that organizes and maintains the set of servers in the server pool (data center) for which resources are managed by the system of the present invention. The server pool director 355 reports any changes in the server pool membership to the policy engine 350. For example, the server pool director 355 will report a change in server pool membership when a server starts or shuts down.

The local workload manager 360 at each server implements (i.e., enforces) the policy decisions made by the policy engine 350 by appropriately controlling the resources at their disposal. A local workload manager 360 runs on each server in the server pool and regulates resources of the local server based on the allocation of resources determined by the policy engine 350. (Note, the policy engine also runs locally on each server). Also, the local workload manager 360 gathers resource utilization data from the various resource monitoring modules, and records this data in the data store 370. A separate interface module (not shown at FIG. 3) interfaces with other third party applications. For example, an MBean component of this interface module may be used for interacting with MBean J2EE components for WebLogic and WebSphere (if applicable). WebLogic is a J2EE application server from BEA Systems, Inc. of San Jose, Calif. WebSphere is a Web-services enabled J2EE application server from IBM of Armonk, N.Y. The component performs the MBean registration, and converts MBean notifications into the appropriate internal system API calls as hereinafter described.

The load balancer modules 380 are used to control hardware load balancers such as F5's Big-IP load balancer (available from F5 Networks, Inc. of Seattle, Wash.) or Cisco's LocalDirector (available from Cisco Systems, Inc. of San Jose, Calif.), as well as software load balancers such as Linux LVS (Linux Virtual Server available from the Linux Virtual Server Project via the Internet (e.g., currently at www.LinuxVirtualServer.org). The load balancing component of the present invention is generic and extensible—modules that support additional load balancers can be easily added to enable use of such load balancers in conjunction with the system of the present invention.

As described above, components of the system of the present invention reside on each of the servers in the managed server pool. The components of the system may communicate with each other using a proprietary communication protocol, or communications among component instances may be implemented using a standard remote procedure call (RPC) mechanism such as CORBA (Common Object Request Broker Architecture). In either case, the system is capable of scaling up to regulate resources of very large server pools and data centers, as well as to manage geographically distributed networks of servers.

### Detailed Operation

Policy Engine and Application of Scripted Policies

The policy engine of the present invention includes support for an “expression language” that can be used to define policies (e.g., policies for allocating resources to applications). The expression language can also be used to specify when the policies should be evaluated and applied. As described above, the policy engine and other components of the system of the present invention operate in a distributed fashion and are installed and operable on each of the servers having resources to be managed. At each of the servers, components of the present invention create an environment for applying the policy-based resource allocation mechanisms of the present invention. This environment maintains a mapping between certain variables and values. Some of the variables are “built in” and represent general characteristics of an application or a resource, as hereinafter described. Other variables can be defined by a user to implement desired policies and objectives.

The policies which are applied by the policy engine and enforced by the system are specified by the user of the system as part of a set of rules comprising an application rule for each application running on the servers in the managed server pool, and a server pool rule. One element of an application rule is the “application definition”, which provides “rules” for grouping application components (e.g., processes, flows or J2EE components) active on a given server in the server pool into an “application instance.” These rules identify the components to be associated with a given application instance and are applied to bring together processes, flows, etc. into “application instance” and “application” entities which are managed by the system. In a typical data center environment, there are literally hundreds of components (e.g., processes) constantly starting and stopping on each server. The approach of the present invention is to consolidate these components into meaningful groups so that they can be tracked and managed at the application instance or application level.

More particularly, a group of processes running at each server are consolidated into an application instance based on the application definition section of the application rule. However, a given application may run across several servers (i.e., have application instances on several servers). In this situation, the application instances across all servers are also grouped together into an “application”.

The application definition also includes rules for the detection of other components, e.g., “flow rules” which associate network traffic with a particular application. For example, network traffic on port 80 may be associated with a Web server application under the “flow rules” applicable to the application. In this manner, consumption of bandwidth resources is also associated with an application. The present invention also supports detecting J2EE components (e.g., of application servers). The system also supports the runtime addition of detection plug-ins by users.

Another element of an application rule is a series of variable declarations. The system associates a series of defined variables with each application instance on each machine. Many of these variables are typically declared and/or set by the user. For instance, a user may specify a “gold customers” variable that can be monitored by the system (e.g., to enable resources allocated to an application to be increased in the event the number of gold customers using the application exceeds a specified threshold). When it is determined that the number of “gold customers” using the application exceeds the threshold, the system may request the allocation of additional resources to the application based upon this condition. It should be noted that these variables may be tracked separately for each server on which the application is running and/or can be totaled across a group of servers, as desired.

In addition to user-defined variables, the system also provides several implicit or “built-in” variables. These variables are provided to keep track of the state and performance of applications and resources running in the server pool. For example, built-in variables provided in the currently preferred embodiment of the system include a “PercCpuUtilServer” variable for tracking the current utilization of CPU resources on a given server. Generally, many of these built-in variables are not instantaneous values, but rather are based on historical information (e.g., CPU utilization over the last five minutes, CPU utilization over a five minute period that ended ten minutes ago, or the like). Historical information is generally utilized as the basis for many of the built-in variables as this approach allows the system to avoid constant “thrashing” that might otherwise result if changes were made based on instantaneous values that can fluctuate significantly over a very short period of time.

An application rule also includes the specification of the policies that the policy engine will apply in managing the application. These policies provide a user with the ability to define actions that are to be taken in response to particular events that are detected by the system. Each policy includes a condition component and an action component. The condition component is similar to an “if” statement for specifying when the associated action is to be initiated (e.g., when CPU utilization of the local server is greater than 50%). When the condition is satisfied, the corresponding action is initiated (e.g., request additional CPU resources to be allocated to the application, execute command specified by the user, or adjust the load balancing parameters). Both the conditions, and the actions that are to be taken by the system when the condition is satisfied, may be specified by the user utilizing an expression language provided as an aspect of the present invention.

The application policies for the applications running in the data center are then replicated across the various nodes (servers). Using the same example described above, when CPU utilization on a particular server exceeds a specified threshold (e.g., utilization is greater than 50%), the application as a whole requests additional resources. In this example, the policy is evaluated separately on each server based on conditions at each server (i.e., based on the above-described variables maintained at each server).

Attributes are also included in the policy to specify when conditions are to be evaluated and/or actions are to be taken. Policy conditions may be evaluated based on particular events and/or based on the expiration of a given time period. For example, an “ON-TIMER” attribute may provide for a condition to be evaluated at a particular interval (e.g., every 30 seconds). An “ON-SET” attribute may be used to indicate that the condition is to be evaluated whenever a variable referred to in the policy condition is set. A user may create policies including conditions that are evaluated at a specified time interval as well as conditions that are evaluated as particular events occur. This provides flexibility in policy definition and enforcement.

The above example describes a policy that is server specific. Policies can also apply more broadly to an application based on evaluation of conditions at a plurality of servers. Information is periodically exchanged among servers by components of the system using an efficient, bandwidth-conserving protocol. The exchange of information among components of the system for example, may be handled using a proprietary communication protocol. This communication protocol is described in more detail in commonly owned, presently pending application Ser. No. 10/605,938 (Docket No. SYCH/0002.0 1), filed Nov. 6, 2003, entitled “Distributed System Providing Scalable Methodology for Real-Time Control of Server Pools and Data Centers”. Alternatively, the components of the system may communicate with each other using a remote procedure call (RPC) mechanism such as CORBA (Common Object Request Broker Architecture).

This exchange of information enables each server to have certain global (i.e., server pool-wide) information enabling decisions to be made locally with knowledge of conditions at other servers. Generally, however, policy conditions are evaluated at each of the servers based on this information. In fact, a policy applicable to a given application may be evaluated at a given server even if the application is not active on the server. This approach is utilized given that a particular policy may be the “spark” that causes the application to be started and run on the server.

A policy may also have additional attributes that specify when action should be taken based on the condition being satisfied. For example, an “ON-TRANSITION” attribute may be specified to indicate that the application is to request additional resources only when the CPU utilization is first detected to be greater than 50%. When the specified condition is first satisfied, the “ON-TRANSITION” attribute indicates that the action should only be fired once. Generally, the action will not be fired again until the condition goes to “false” and then later returns again to “true”. This avoids the application continually requesting resources during a period in which the condition remains “true” (e.g., while utilization continues to exceed the specified threshold).

Similarly, an ATOMICITY attribute may be used to specify a time interval during which the policy action can be performed only once across the entire server pool, even if the policy condition evaluates to TRUE more than once, on the same server or on any set of servers in the pool.

As another example, the methodology of the present invention enables a change in resource allocation to be initiated based on a rate of change rather than the simple condition described in the above example. For instance, a variable may track the average CPU utilization for a five minute period that ended ten minutes ago. This variable may be compared to another variable that tracks the CPU utilization for the last five minutes. A condition may provide that if the utilization over the last five minutes is greater than the utilization ten minutes ago, then a particular action should be taken (e.g., request additional resources).

Although conditions are evaluated at each server, policies may be defined based on evaluating conditions more globally as described above. For instance, a user may specify a policy that includes a condition based on the average CPU utilization of an application across a group of servers. A user may decide to base a policy on average CPU utilization as it can serve as a better basis for determining whether an application running on multiple servers may need additional resources. The user may, for example, structure a policy that requests additional resources be provided to an application in the event the average CPU utilization of the application on the servers on which it is running exceeds a specified percentage (e.g., >50%). If, for example, the application was running on three servers with 20% utilization on the first server, 30% utilization on the second, and 60% utilization on the third, the average utilization would be less than 50% and the application would not request additional resources. In contrast, if looking at each server individually, the same condition would trigger a request for additional resources based on the 60% utilization at the third server.

A user may define polices based on looking at a group of servers (rather than a single server). A user may also define policies that examine longer periods of time (rather than instantaneous position at a given time instance). These features enable a user to specify policy conditions that avoid (or at least reduce) making numerous abrupt changes (i.e., thrashing or churning) in response to isolated, temporary conditions. Those skilled in the art will appreciate that typical server pool environments are of such complexity that taking a snapshot of conditions at a particular instant does not always provide an accurate picture of what is happening or what action (if any) should be taken to improve performance.

The system of the present invention can also be used in conjunction with resources external to the server pool, such as load balancers, to optimize the allocation of system resources. Current load balancers provide extensive functionality for balancing load among servers. However, they currently lack facilities for understanding the details about what is happening with particular applications. The system of the present invention collects and examines information about the applications running in the data center and enables load balancing adjustments to be made based on the collected information. Other external devices that provide an application programming interface (API) allowing their control can be controlled similarly by the system. For example, the system of the present invention can be used for controlling routers (e.g., for regulating bandwidth) and provisioning devices (external servers running specialized software). The application rules that can be specified and applied by the policy engine will next be described in more detail.

Application Definition

The system of the present invention automatically creates an inventory of all applications running on any of the servers in the server pool, utilizing application definitions supplied by the user. The application definitions may be modified at any time, which allows the user to dynamically alter the way application components such as processes or flows are organized into application instances and applications. Mechanisms of the system identify and logically classify processes spawned by an application, using attributes of the operating system process hierarchy and process execution environment. A similar approach is used to classify network traffic into applications, and the system can be extended easily to other types of components that an application may have (e.g., J2EE components of applications).

The system includes a set of default or sample rules for organizing application components such as processes and flows into typical applications (e.g., web server applications). Application rules are currently described as an XML document. A user may easily create and edit custom application rules and thus define new applications through the use of the system's GUI or command line interface. The user interface allows these application rules to be created and edited, and guides a user with the syntax of the rules.

Processes, flows and other entities are organized into application instances and applications based on the application definition section of the application rule set. In the currently preferred embodiment, an XML based rule scheme is employed which allows a user to instruct the system to detect particular applications. The XML-based rule system is automated and configurable and may optionally be used to associate policies with an application. The user interface allows these rules to be created and edited, and guides the user with the syntax of the rules. A standard “filter” style of constructing rules is used, similar in style to electronic mail filter rules. The user interface allows the user to select a number of application components and manually arrange them into an application. The user can then explicitly upload any of the application rules stored by the mechanism (i.e., pass it to the policy engine for immediate enforcement).

The application definitions are used to specify the operating system processes and the network traffic that belong to a given application. As described above, process rules specify the operating system processes that are associated with a given application, while flow rules identify network traffic belonging to a given application. An example of a process rule in XML format is as follows:

```
  1: ...
  2: <APPLICATION-DEFINITION>
  3: <PROCESS-RULES>
  4: <PROCESS-RULE INCLUDE-CHILD-PROCESSES=“YES “>
  5: <PROCESS-NAME>httpd</PROCESS-NAME>
  6: </PROCESS-RULE>
  7: ...
  8: </PROCESS-RULES>
  9: ...
10: </APPLICATION-DEFINITION>
```

The above process rule indicates that all processes called httpd and their “child” processes are defined to be part of a particular application.

In a similar fashion, flow rules specify that network traffic associated with a certain local IP address/mask and/or a local port belongs to a particular application. For example, the following flow rule specifies that traffic to local port 80 belongs to a given application:

```
  1: <APPLICATION-DEFINITION>
  2: ...
  3: <FLOW-RULES>
  4: <FLOW-RULE</FLOW-RULE>
  5: <LOCAL-PORT>80</LOCAL-PORT>
  6: </FLOW-RULE>
  7: ...
  8: </FLOW-RULES>
  9: </APPLICATION-DEFINITION>
10: ...
```

The presently preferred embodiment of the system includes a set of default or sample application rules comprising definitions for many applications encountered in a typical data center. The system's user interface enables a user to create and edit these application rules. An example of an application rule that may be created is as follows:

| 1: <APPLICATION-RULE NAME=“AppDaemons”> | |
|---|---|
| 2: <APPLICATION-DEFINITION> | |
| 3: <PROCESS-RULE> | |
| 4: <PROCESS-VALIDATION-CLAUSES> | |
| 5. <CMDLINE>appd.*</CMDLINE> | |
| 6: </PROCESS-VALIDATION-CLAUSES> | |
| 7. </PROCESS-RULE> | |
| 8. <FLOW-RULE> | |
| 9. <FLOW-VALIDATION-CLAUSES> | |
| 10. <LOCAL-PORT>3723</LOCAL-PORT> | |
| 11. </FLOW-VALIDATION-CLAUSES> | |
| 12. </FLOW-RULE> | |
| 13. </APPLICATION-DEFINITION> | |
| 14. <APPLICATION-POLICY> | |
| 15: ... | |
| 16: | </APPLICATION-POLICY> |
| 17: | </APPLICATION-RULE> |

As illustrated in the above example, the application definition for a given application may include rules for several types of application components, e.g., process and flow rules. This enables the system to detect and associate both CPU usage and bandwidth usage with a given application.

Resource Monitoring

The system also collects and displays resource usage for each application over the past hour, day, week, and so forth. This resource utilization information enables data center administrators to accurately estimate the future demands that are likely to be placed on applications and servers. Currently, the information that is gathered by the system while it is running includes detailed information about the capacity of each monitored server. The information that is collected about each server includes its number of processors, memory, bandwidth, configured IP addresses, and the flow connections made to the server. Also, within each server pool, per-server resource utilization summaries indicate which servers are candidates for supporting more or less workload. The system also collects information regarding the resources consumed by each running application. A user can view a summary of historical resource utilization by application over the past hour, day, week, or other interval. This information can be used to assess the actual demands placed on applications and servers over time.

The information collected by the system about applications and resources enable the user to view various “what if” situations to help organize the way applications should be mapped to servers, based on their historical data. For example, the system can help identify applications with complementary resource requirements that are amenable to execution on the same set of servers. The system can also help identify applications that may not be good candidates for execution on the same servers owing to, for example, erratic resource requirements over time.

Understanding J2EE Applications

The system can monitor the behavior of J2EE (Java 2 Enterprise Edition) application servers, such as WebLogic, WebSphere or Oracle 8i AS, using an MBean interlace so that predefined actions can be taken when certain conditions are met. For example, the system can receive events from a WebLogic application server which inform the system of the WebLogic server's status, (e.g., whether it is operational, or the average number of transactions per thread). These metrics can then be matched against actions defined by the user in the system's application policies, to determine whether or not to make environmental changes with the aim of improving the execution of the application. The actions that may be taken include modifying the application's policy, issuing an “explicit congestion notification” to inform network devices (e.g., routers) and load balancers to delay or reroute new requests, or to execute a local script.

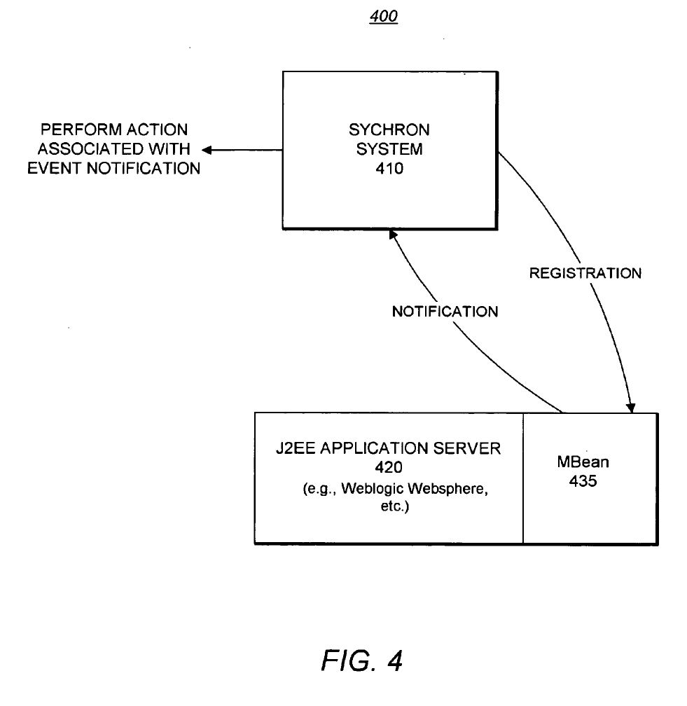

FIG. 4 is a block diagram illustrating an environment 400 demonstrating the interaction between the system of the present invention and a third party component. In this example, the system interacts with a J2EE application server. As shown, the Sychron system 410 establishes a connection to the J2EE application server 420 in order to request its MBean 435. The application server 420 validates the security of the request and then sends the MBean structure to the Sychron system 410. The Sychron system 410 then registers with the application server 420 to get notified whenever certain conditions occur within the application server 420. The user of the Sychron system 410 may then configure application detection rules and application policies specifying the events to register for, and the consequential actions to be initiated by the system of the present invention when such events occur within the application server 420. This is one example illustrating how the system may interact with other third party components. A wide range of other components may also be used in conjunction with the system.

Monitoring Server Pools

After application rules have been established, the consumption of the aggregated

CPU and memory and resources of a server pool by each application or application instance is monitored and recorded over time. In the system's currently preferred embodiment, the information that is tracked and recorded includes the consumption of resources by each application; usage of bandwidth by each application instance; and usage of a server's resources by each application instance. The proportion of resources consumed can be displayed in either relative or absolute terms with respect to the total supply of resources.

In addition, the system can also display the total amount of resources supplied by each pool, server, and pipe to all of its consumers of the appropriate kind over a period of time. In other words the system monitors the total supply of a server pool's aggregated CPU and memory resources; the server pool's bandwidth resources; and the CPU and memory resources of individual servers.

Scenario Modeling

The system provides a number of features for modeling the allocation of resources to various applications. A resource monitoring tool provided in the currently preferred embodiment is a “utilization summary” for a resource supplier and consumer. The utilization summary can be used to show its average level of resource utilization over a specified period of time selected by the user (e.g., over the past hour, day, week, month, quarter, or year). For example, for each server pool, server, pipe, application, and instance, during a set period, the user interface can display the average resource utilization expressed as a percentage of the total available resources. The system can aggregate the utilization charts of several user-selected applications in order to simulate the execution of such applications on a common set of servers. This capability is useful in determining the most complementary set of applications to run on the same cluster for optimal utilization of server resources. These features also assist IT organizations in planning, such as projecting the number of servers that may be needed in order to run a group of applications.

The system of the present invention can also be used in conjunction with third party performance management products such as Veritas i3 (available from Veritas Software Corporation of Mountain View, Calif.), Wily IntroScope (available from Wily Technology of Brisbane, Calif.), Mercury Optane/Topaz (available from Mercury Interactive Corporation of Mountain View, Calif.), or the like. These performance management products monitor performance of server-side Java and J2EE applications. These solutions can provide detailed application performance data generated from inside an application server environment, such as response times from various Java/J2EE components (e.g., servlets, Enterprise Java Beans, JMS, JNDI, JDBC, etc.), all of which can be automatically captured in the system's policy engine. For example, an application server running a performance management product may periodically log its average transaction response time to a file. A policy can be created which queries this file and, through the policy engine of the present invention, specify that more server power is to be provided to the application whenever the application's transaction response time increases above 500 milliseconds. The following discussion will describe the application management provided by the system of the present invention by presenting the various elements of a sample application rule that may be created and enforced in the currently preferred embodiment of the system.

### General Structure of Application Rules

Application Name

Each application has a unique name, which is specified at the top of the application rule as illustrated by the following example:

1: <APPLICATION-RULE NAME=“WebServer” BUSINESS-
PRIORITY=“100” POWER-SAVING=“NO”>
2: ...
3: </APPLICATION-RULE>

As shown, the name of this example application is “WebServer”. Optionally, a business priority and/or the power saving flag may be specified at the same time. As shown above, the default values for the optional application parameters are “100” for the business priority and “NO” for the power saving flag. The latter is asking the system to never power off a server on which the application is running. This mechanism can be used to instruct the system to power off servers that are idle, until they are needed again.

Application Definition

Another aspect of an application policy is the application definition for identifying the components of an application. As described above, process rules and flow rules specify the operating system processes and the network traffic that are associated with a particular application. The system uses these rules to identify the components of an application. All components of an application are managed and have their resource utilization monitored as a single entity, with per application instance breakdowns available for most functionality.

The definition section of an application rule comprises a non-empty set of rules for the detection of components including (but not limited to) processes and flows. For instance, each process rule specifies that the operating system processes with a certain process name, process 10, user 10, group 10, session 10, command line, environment variable(s), parent process name, parent process 10, parent user 10, parent group 10, and/or parent'session 10 belong to a particular application. Optionally, a user may declare that all child processes of a given process belong to the same application. Similarly, a flow rule specifies that the network traffic associated with a certain local IP address/mask and/or local port belongs to the application.

Reference Resources

Reference (or “default”) resources for an application can be specified in a separate section of the application rule. These represent the resources that the system should allocate to an application when it is first detected. For example, the CPU power allocated to an application may be controlled by allocating a certain number of servers to an application.

As described below, policies can also be specified that cause resource adjustments to be made in response to various conditions and events. For example, policies can request that the application resources change from the default, reference values when certain events occur. Also, a policy can cause the issuance of a request to reinstate the default (or reference) resources specified for an application. An example of a reference (default) application resource specification that continues the definition of the application policy for the above “WebServer” application is as follows:

| | |
|---|---|
| 1: | ... |
| 2: | <DEFAULT-RESOURCES RESOURCE=“CPU”> |
| 3: | <POOL-RESOURCES TYPE=“ABSOLUTE”> 5000 </POO |
| | L-RESOURCES> |
| 4: | <SERVER-RESOURCES> |
| 5: | <RESOURCE-VALUE RANGE=“REQUESTED” TYPE=“AB |
| | SOLUTE”>750</RESOURCE-VALUE> |
| 6: | </SERVER-RESOURCES> |
| 7: | </DEFAULT-RESOURCES> |
| 8: | ... |

The units of CPU power are expressed in MHz. As shown above, the default CPU requested across all servers in the server pool is 500 MHz. These requested resources are specified as absolute values. Alternatively, the value of the default resources requested by an application can be expressed as a percentage of the aggregated CPU power of the server pool rather than as absolute values. The resources that an application should be allocated on a specific server or set of servers can be specified in addition to the overall resources that the application needs. In the example above, on each server on which the application is allocated resources, the “per server” amount of CPU requested is 750 MHz.

An additional RESOURCE-VALUE can be specified for RANGE=“AT-LEAST”, to indicate the minimum amount of CPU that is acceptable for the application on a single server. This value is used by the policy engine to decide whether a server on which the requested resources are not available can be used for an application when available resources are scarce within the server pool. It should be noted that changing the reference resources in the application policy of an existing application is usually applied immediately if the application is set up to use its reference level of resources. Otherwise, the change is applied the next time a policy requests the system to use the reference level of resources for the application.

Load Balancing Rules

An application policy may optionally include a set of reference “load balancing” rules that specify the load balancing parameters that the system should use when it first detects an application. Similar to other resources managed by the system (e.g., CPU), these parameters can also be changed from their default values by policies in the manner described below. Policies may also cause the issuance of requests to return these load balancing rules to their default, reference values.

Application Server Inventory

The “application server inventory” section of an application rule specifies the set of servers on which the application can be suspended/resumed by the system in order to realize the application resource requirements. More particularly, a “suspend/resume” section of the application server inventory comprises a list of servers on which the system is requested to suspend and resume application instances as necessary to realize the application resource requirements. Application instances are suspended (or “deactivated”) and resumed (or “activated”) by the system on these servers using user-defined scripts. These scripts are identified in the “application control” section of an application rule as described below. An example of specifying “suspend/resume” servers for the example “WebServer” application is as follows:

| 1: ... | |
|---|---|
| 2: <SERVER-INVENTORY> | |
| 3: <SUSPEND-RESUME-SERVERS> | |
| 4: <SERVER> node 19.acme.com </SERVER> | |
| 5: <SERVER> node20.acme.com </SERVER> | |
| 6: <SERVER> node34.acme.com </SERVER> | |
| 7: </SUSPEND-RESUME-SERVERS> | |
| 8: ... | |
| 9: </SERVER-INVENTORY> | |
| 10: | ... |

As shown above, three nodes are specified as suspend/resume servers for the “WebServer” application: “node19.acme.com”, “node20.acme.com”, and “node34.acme.com”. The user is responsible for ensuring that the application is properly installed and configured on all of these servers. Also, the user provides suspend/resume scripts that perform the two operations. The suspend/resume scripts should be provided by the user in the application control section of the application policy.

The application server inventory section of an application policy may also include “dependent server sets”, i.e., server sets whose allocation to a particular application must satisfy a certain constraint. These represent disjoint sets of servers which can be declared as “dependent” on other servers in the set. Server dependencies are orthogonal to a server being in the suspend/resume server set of an application, so a server that appears in a dependent server set mayor may not be a suspend/resume server. Each dependent server set has a constraint associated with it, which defines the type of dependency. Several constraint types are currently supported. One constraint type is referred to as a “TOGETHER” constraint, which provides that the application must be allocated either all of the servers in the set or none of the servers in the set. Another constraint type that is currently supported is an “ALL” constraint, which indicates that the application must be active on all dependent servers. The “ALL” constraint can be used to specify a set of one or more servers that are mandatory for the application (i.e., a set of servers that must always be allocated to the application). Additional constraint types that are currently supported include “AT-LEAST”, “AT-MOST”, and “EXACTLY” constraints.

The following example shows a portion of an application rule specifying a set of dependent servers for the example “WebServer” application:

1: ...
2: <SERVER-INVENTORY>
3 ...
4: <DEPENDENT-SERVERS
NAME=“PRIMARY-BACKUP-SERVERS”
CONSTRAINT=“TOGETHER”>
5: <SERVER> node 19.acme.com < /SERVER>
6: <SERVER> node34.acme.com </SERVER>
7: </DEPENDENT-SERVERS>
8: </SERVER-INVENTORY>
9: ...

As shown above, “node19.acme.com” and “node34.acme.com” are described as dependent servers of the “TOGETHER” type for the “WebServer” application. This indicates that the application should be active on both of these servers if it is active on one of them.

Application Control

The “application control” section of an application policy can be used to specify a pair of user-defined scripts that the system should use on the servers listed in the “suspend/resume” section of the server inventory (i.e., the severs on which the application can be suspended/resumed by the system). These user-defined scripts are generally executed whenever one of these servers is allocated (or no longer allocated) to the application. This “application control” section is currently mandatory if “suspend/resume” servers are specified in the “server inventory” section of the application rule. An example is as follows:

1: ...
2: <APPLICATION-CONTROL>
3: <SUSPEND-SCRIPT> /etc/init.d/httpd stop</SUSPEND-SCRIPT>
4: <RESUME-SCRIPT> /etc/init.d/httpd start</RESUMESCRIPT>
5: </APPLICATION-CONTROL>
6: ...

The system uses the specified suspend script at line 3 when it decides to change the state of an application instance from active to inactive on a server that belongs to the suspend/resume set of the application. The resume script at line 4 is used when the system decides to change the state of an application instance from inactive (or stopped) to active on a server that belongs to the application's suspend/resume set.

Application Policies

The unique application state and policies of the present invention provide a framework for specifying changes to resource allocations based on the state of the applications and resources in the data center. For example, if the resource utilization of a particular application becomes significantly larger than the resources allocated to the application (e.g., as specified in the default resources section of the application rule), then an alert can be generated, and/or the resources allocated to the application altered (e.g., resulting in the application being started on more servers in the server pool).

The framework of the present invention is based on an abstraction that includes an expression language containing user-defined variables and built-in variables provided as part of the system. The built-in variables identify a characteristic of the running application instance, for example, the CPU utilization of an application instance. The system includes a user application programming interface (API) for setting and retrieving variables that are local to application instances. The system is extended with a runtime environment that maintains a mapping between variables and associated values for each application instance on each server of the server pool, including the servers on which the application instance is stopped. A server's environment and/or the state of the application is continually updated whenever the user calls a “set” method of the API on a particular server. The policies provided by the system and the expression language used in their construction are described below in greater detail.

Application Variables

The “application variables” section of an application rule is for the specification of user-defined variables. These user-defined variables are variables that are used to define policy conditions.

Application Priority

An “application priority” is currently structured as a positive integer that specifies the relative priority of the application compared to other applications. The system consults and uses these application priorities to resolve contention amongst applications for resources. For example, in the event of contention by two applications for particular resources, the resources are generally allocated to the application(s) having the higher priority ranking (i.e., higher assigned priority value).

Application Power-Saving Flag

An “application power-saving flag” is a parameter of an application rule that is used by the server management component of the system to decide whether a given server can be powered off (as described below in more detail). If a server is allocated to a set of applications by the system, the instances of these applications running on that server are termed an “active application instances.” All instances of other applications that are running on the same server, but are not currently assigned resources on the server, are termed “inactive application instances.” The manner in which the system of the present invention allocates server resources to applications in order to fulfill the application policies is described below.

Server Pool Rule

The system's management of servers is defined by “server pool” rule established by the user. The server pool rule may include “server control” rules which specify user-defined commands for powering off and powering on each server that is power managed by the system. The server pool rule may also include “dependent server” rules specifying disjoint server sets whose management is subject to a specific constraint. One type of constraint currently supported by the system is an “AT-LEAST” construct that is used to specify a minimum number of servers (of a given set of servers) that must remain “powered on” at all times. An empty server set can be specified in this section of the server pool rules, to denote all servers not listed explicitly in other dependent server sets. The server pool rule can be augmented with additional sections to specify the allocation of CPU power of individual servers and/or to configure the server pool pipes on startup. The way in which the system can be used to power manage servers is described below in this document. Before describing these power management features, the operations of the policy engine in allocating resources to applications will be described in more detail.

### Operations of Policy Engine

Policy Engine Management of Server Resources

The system's policy engine is designed to comprehensively understand the real-time state of applications and the resources available within the server pool by constantly analyzing the fluctuating demand for each application, the performance of the application, and the amount of available resources (e.g., available CPU power). The policy engine provides full automation of the allocation and re-allocation of pooled server resources in real time, initiating any action needed to allocate and control resources to the applications in accordance with the established policies.

The policy engine can be used to flexibly manage and control the utilization of server resources. Users can establish a wide range of policies concerning the relative business priority of each application, the amount of server processing power required by the application and/or the application's performance—all centered on ensuring that the application consistently, predictably, and efficiently meets service level objectives. The policies which may be defined by users and enforced by the system may include business alignment policies, resource level policies, and application performance policies.

Business alignment policies determine the priority by which applications will be assigned resources, thus allowing for business-appropriate brokering of resources in any instance where contention for resources may exist. This dynamic and instantaneous resource decision making allows another layer of intelligent, automatic control over key server resources.

Resource level policies allow users to specify the amount of system resources required by particular applications. Asymmetric functionality gives the system the ability to differentiate between the computing power of a 2-way, 4-way, or 8-way (or more) server when apportioning/aggregating power to an application. This enables optimal use of server resources at all times.

Application performance policies enable users to specify application performance parameters. Application performance policies are typically driven by application performance metrics generated by third-party application performance management (APM) tools such as Veritas i3, Wily IntroScope, Mercury Optane/Topaz, and the like.

Application Resources

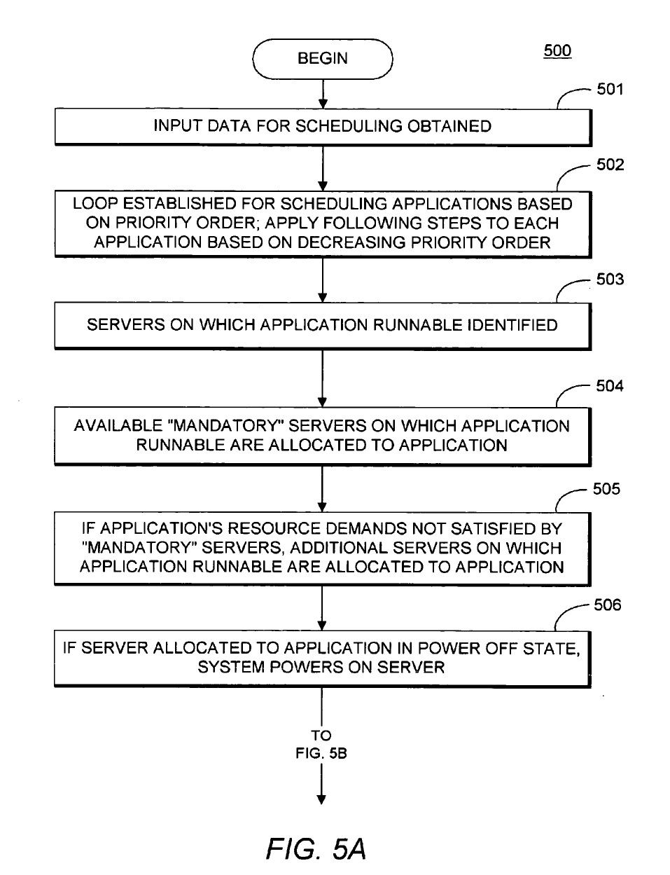

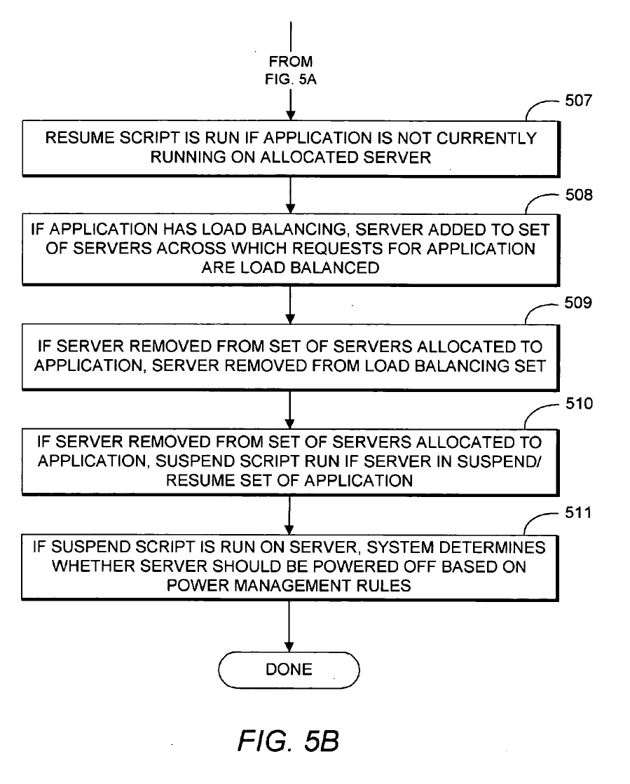

An application rule may optionally associate resources with an application. The reference or default resource section of an application rule may specify the amount of resources that system should allocate to the application, subject to these resources being available. Currently, the system provides resource control for allocating CPU power to an application. A user may also configure criteria for determining the server(s) to be allocated to an application. For example, a full set of servers may be allocated to an application such that the aggregated CPU power of these servers is equal to or exceeds the application resources. FIGS. 5A-B comprise a single flowchart 500 describing at a high-level the scheduling methodology used to allocate servers to applications in the currently preferred embodiment of the system. This scheduling methodology allocates resources to applications based on priorities configured by the user (e.g., based on business priority order specified by the user in the application rules). The following description presents method steps that may be implemented using processor-executable instructions, for directing operation of a device under processor control. The processor-executable instructions may be stored on a computer-readable medium, such as CD, DVD, flash memory, or the like. The processor-executable instructions may also be stored as a set of downloadable processor-executable instructions, for example, for downloading and installation from an Internet location (e.g., Web server).

At step 501, the input data for the scheduling methodology is obtained. The data used for scheduling includes the set of servers in the server pool, the set of applications running on the servers, the specified priority of each application (e.g., ranking from highest priority to lowest priority), resources, and server inventories, and the current state of applications. At step 502, a loop is established for performing the following steps for scheduling each application based on the specified priority of each application. The following steps are then applied to each application in decreasing application priority order.

At step 503, the servers on which the application is “runnable” are identified. The servers on which the application is runnable includes the servers on which the system detects the application to be running. It also includes all the “suspend/resume” servers for the application, including those which have been powered off by the system as part of its power management operations.

At step 504, all “mandatory” servers (i.e., designated servers specified in the application rule with an ALL constraint) that are available and on which the application is runnable are allocated to the application. It should be noted that a mandatory server may not be available because it is not a member of the server pool, or because it has already been allocated to a higher priority application. An error condition is raised if the application cannot be allocated the “at least” portion of its mandatory servers.

If the application's resource demands are not met by the aggregated CPU power of the mandatory servers allocated to the application, then commencing at step 505 additional servers on which the application is runnable are allocated to the application. One such server or one set of dependent servers (e.g., a set of “TOGETHER” dependent servers as described above) is allocated at a time, until the aggregated CPU power of all servers allocated to the application is equal to or exceeds the resources requested by the application, or until all eligible/available servers are allocated to the application. If an application's resource demands are not satisfied despite the allocation of all eligible/ available servers, an error condition is raised.

A number of criteria are used to decide the server or set of dependent servers to be allocated to the application at each step of the process. Preference is given to servers based on criteria including the following: no other application is runnable on the server; the application is already active on the server; the application is already running on the server, but is inactive; the server is not powered off by the system's power management capability; and the server CPU power provides the best match for the application's resource needs. The order in which these criteria are applied is configurable by the user of the system. Additionally, in a variant of the system, further criteria can be added by the user while the system is running.

The actions described below are taken when a server is first allocated to an application, and when a server is no longer allocated to an application, respectively. When a server is first allocated to an application, the server may be in a powered-off state (e.g., as a result of power management by the system). If this is the case, then at step 506 the server is powered on by the system (as described below), and the next steps are performed after the server joins the server pool.

When a server is first allocated to an application, the application may not be running on that server. This may be the case if the server is in the “suspend/resume” server set of the application. In this event, at step 507 the resume script specified by the user in the application control section of the application policy is executed by system. When the application has a running instance on the allocated server (possibly after the resume script was run and exited with a zero exit code indicating success), and if the application has load balancing, at step 508 the server is added to the set of servers across which requests for the application are load balanced.

Certain steps are also taken when a server is removed from the set of servers allocated to an application. If a server is removed from the set of servers allocated to an application and if the application has load balancing, at step 509 the server is removed from the set of servers across which requests for the application are load balanced. Additionally, if the server belongs to the set of suspend/resume servers of the application, then at step 510 the suspend script specified by the user in the application control section of the application policy is executed by the system. It should be noted that the suspend script must deal appropriately with any ongoing requests that the application instance to be suspended is handling. Lastly, if a suspend script is executed and the application is no longer running on the server as a result of the suspend script, at step 511 the system determines whether the server should be powered off based upon the system's power management rules.

Expression Language for Specifying Policies

As discussed above, the present invention also provides for policies to adjust the allocation of resources from time to time based on various conditions. For instance, whenever a user sets an application variable, an application instance is identified by the setting call, and the particular local variable identified by the set is updated in the runtime application environment on a particular server. Once a variable has been set, all the policy condition(s) of the particular application instance identified by the set are reevaluated based upon the updated state of the application environment.

The expression language used to specify the policy condition(s) is similar to the expression language used, for example, in an Excel spreadsheet. The language provides a variety of arithmetic and relational operators based on double precision floating point values, along with functions based on groups of values such as “SUM( )”, “AVERAGE( )”, “MAX( )”, and so forth. When a condition is evaluated, if a variable is used in a simple arithmetic operation, then the value on that particular server is used. For example, given a “cpu” variable that identifies the percentage CPU utilization of an application on a server, then the expression “cpu<50.0” is a condition that identifies whether an application instance is running at less than half the capacity of the server. If a variable is used in one of the group functions such as “SUM( )”, then the values from all servers are used by the function, and a single value is returned. For example, the condition “cpu>AVERAGE(cpu)” is true on those servers which are more heavily loaded than the average CPU utilization for the application.

The policy may provide for certain action(s) to be taken if the condition is satisfied. For instance, any condition that evaluates to a non-zero value (i.e., “true”) will have the associated action performed. Alternatively, the policy attributes may require that the action is performed each time when the condition value changes from zero (i.e., “false”) to non-zero (i.e., “true”). The associated policy action may, for instance, cause a script to be executed. In the following sections the user API and the extensions to the application rules are presented, along with a series of examples that illustrate how the methodology of the present invention can be utilized for allocating system resources.

Examples of User API for Application Variables

The following code segment shows the API of the system of the currently preferred embodiment for setting and retrieving application variables:

1: void sychron_set_app_variable(

| | |
|---|---|
| 2: const char | *variable, |
| 3: double | value, |

4: sychron_app_component_t id,

| | |
|---|---|
| 5: app_variable_err_t | *err); |

```
  6:
  7:
  8: double sychron_get_app_variable(
```

| | |
|---|---|
| 9: const char | *variable, |

10: sychron_app_component_t id,

| | |
|---|---|
| 11: app_variable_err_t | *err); |

12:
13: typedef struct {
14: enum {

| | | |
|---|---|---|
| 15: | NoError, | InternalError, |

| | |
|---|---|
| 16: | UndefinedComponent, UndefinedVariable, |

| | |
|---|---|
| 17: UnsetVariable, | SyntaxError |

18: } code;
19: char *msg;
20: } app_variable_err_t ;
21:
22: typedef enum { Process,App } sychron_app_component_ident_t;
23:
24: typedef struct {
25: sychron_app_component_ident_t type;
26: union {
27: pid_t pid;
28: swm_app_id app_id;
29: } ;
30: } sychron_app_component_t;

The function “sychron_set_app_variable( )” takes as its argument a string describing an application variable, a double precision floating point value to be set, and a unique identifier that identifies an application instance. The “sychron_get_app_variable( )” retrieval function returns the value represented by the variable in the application detection rule environment. If the variable is not defined, exported by the application detection rules (as described below), is not currently set, or if a more complex expression is used that contains a syntax error, then an exception will be raised.

The system includes a command line interface tool for setting and reading the variables associated with applications. One primary use of the command line interface tool is from within the scripts that can be executed based on the application detection rules. The command line interface allows the scripts to have access to any of the variables in the application detection environment. To refer to a specific application variable, the tool takes as arguments an application (or “app”) ID, a process ID, and a name and/or identifier of the server on which the application instance is running.

Defining an Application Variable

The following is an excerpt from the application detection DTD for defining variables, along with an example of its use:

1: <!ELEMENT APPLICATION-VARIABLES (VARIABLE)+>
2: <!ELEMENT VARIABLE (#PCDATA>>
3: <!ATTLIST VARIABLE EXPORT (YESINO) “NO”>
4:
5: <APPLICATION-VARIABLES>
6: <VARIABLE EXPORT=“YES”>
MBean_PendingThreadCurrentCount</VARIABLE>
7: <VARIABLE>MBean_PendingRequestCurrentCount</VARIABLE>

| | |
|---|---|
| 8: | </APPLICATION-VARIABLES> |

The above application variable definition is used within an application policy and defines those user-defined variables that are pertinent to the application policy. A variable defined in a “VARIABLE” clause can be used in any of the conditional clauses of an application policy. If the variable is defined to have the “EXPORT” attribute equal to “yes” (e.g., as shown at line 6 above), then the variable can be used within the expression passed as an argument to the “sychron_get_app_variable( )” API function. By default, variables are not exported, as doing so makes them globally visible between the servers in a server pool. If a variable is not defined as a global variable, and is not used within any of the group operators such as “SUM( )”, then setting the variable will only update the local state on a particular server. This makes it considerably more efficient to set or retrieve the variable.

The following lists some variables that are automatically set by the system of the present invention if they are defined in the variable clause of the application detection rule for a particular application. By default, none of these variables are set for a particular application. It is the responsibility of the user to define the variables if they are used in the application policy, or are visible for retrieval (or “getting”) from the user API.
Server: The amount of time in seconds that a server was active during a requested evaluation period
AbsCpuServer: Absolute CPU power of the server a application instance is running on (the same for all applications on a particular node)
AbsCpuHeadroomServer: Absolute CPU headroom available on the server (i.e., the amount of CPU left on a server after deducting the usage of all running applications)
PercCpuHeadroomServer: Percentage CPU headroom available on the server
AbsCpuBookingPool: Current absolute CPU bookings available on the pool
PercCpuBookingPool: Current percentage CPU bookings available on the pool
AbsServerBookingPool: Current absolute number of servers booked in the pool (Note there is no percentage booking of servers in pool as this is captured by PercCpuBookingPool)
AbsMemServer Absolute memory size of the server an application instance is running on (value is constant for a particular server)
AbsTxPool: Absolute pool-wide transmission bandwidth of the default pipe (only changes if the pipes are reconfigured)
AbsRxPool: Absolute pool-wide receive bandwidth of the default pipe (only changes if the pipes are re-configured)

The following application-related variables are also automatically set by the system:
Running: The amount of time in seconds that the application was active over the requested evaluation period
PercCpuUtilServer: CPU utilization as a percentage of a server
PercCpuUtilPool: CPU utilization as a percentage of the pool
AbsCpuUtilServer: CPU utilization of a server in MHz
PercMemUtilServer: Memory utilization as a percentage of a server
PercMemUtilPool: Memory utilization as a percentage of the pool
AbsMemUtilServer: Memory utilization of a server in KB
PercTxUtilPool: Transmission bandwidth of application as a percentage of the default pipe
AbsTxUtilPool: Transmission bandwidth of application from the shared pool wide pipe
PercRxUtilPool: Reception bandwidth of application as a percentage of the default pipe
AbsRxUtilPool: Reception bandwidth of application from the shared pool wide pipe

The following resource-related variables for an application are also set by the system:
PerCpuReqResPool: The last requested CPU resources as a percentage of the pool
AbsCpuReqResPool: The last requested CPU resources of the pool in MHz
PercCpuResPool: The current realized resources as a percentage of the pool
AbsCpuResPool: The current realized resources of the pool in MHZ
AbsServerResPool: The current realized resources as a number of servers

Example of a Policy

The following is an excerpt from the application rule DTD for defining policies, together with an example of its use:

1: <!ELEMENT APPLICATION-POLICY (POLICY-CONDITION,

POLICY-ACTION>>

2: <!ATTLIST APPLICATION-POLICY NAME CDATA #REQUIRED

| | |
|---|---|
| 3: | EVAL-PERIOD CDATA #IMPLIED> |

4: <!ELEMENT POLICY-CONDITION (#PCDATA>>

| | |
|---|---|
| 5: | <!ATTLIST POLICY-CONDITION CHECK (ON-SET\|ON- |

TIMER) ON-TIMER

| | |
|---|---|
| 6: | TIMER CDATA #IMPLIED> |

```
  7: <!ELEMENT POLICY-ACTION (POLICY-RESOURCES|POLI
CY-SCRIPT|POLICY-LB)>
  8: <!ATTLIST POLICY-ACTION WHEN (ON-TRANSITION |
ON-TRUE)
ON-TRANSITION
```

| | |
|---|---|
| 9: | ATOMICITY CDATA #IMPLIED> |

10: <!ELEMENT POLICY-RESOURCES (POOL-RESOURCES?
,SERVER-RESOURCES*)>
11: <!ATTLIST POLICY-RESOURCES TYPE (SET,ADD,SUB
,DEFAULT) #REQUIRED

| | |
|---|---|
| 12: | RESOURCE CDATA #REQUIRED> |

| | |
|---|---|
| 13: | <!ELEMENT POLICY-SCRIPT (#PCDATA)> |
| 14: | <!ELEMENT POLICY-LB (LB-PARAMS*)> |
| 15: | <!ATTLIST POLICY-LB TYPE (ADJUST,DEFAULT) #RE |

QUIRED

| | |
|---|---|
| 16: | IP CDATA #REQUIRED |
| 17: | PORT CDATA #REQUIRED |
| 18: | PROTOCOL (TCPI UDP) “TCP”> |

19:
20: <APPLICATION-POLICY EVAL-PERIOD=“10”>
21: <POLICY-CONDITION CHECK=“ON-TIMER” TIMER=“
10”>

| | |
|---|---|
| 22: | GT(PercCpuUtilPool, 10) |
| 23: | </POLICY-CONDITION> |
| 24: | <POLICY-ACTION WHEN=“ON-TRANSITION” ATOMI |

CITY=“60”>

| | |
|---|---|
| 25: | < POLICY- SCRIPT>/var/ run/ my_scri pt< / |
| | POLICY-SCRIPT> |
| 26: | </POLICY-ACTION> |

27: </APPLICATION-POLICY>

As previously described, a policy has both a condition and an associated action that is performed when the condition is satisfied. The above condition has attributes “EVALPERIOD” and “CHECK”. The attribute “EVAL-PERIOD” is the time-interval, in seconds, with respect to which any built-in variables are evaluated. For example, if the “EVAL-PERIOD” attribute is set to 600, that means that if the variable “PercCpuUtilPool” is used within the pool, then the variable represents the average CPU utilization of the pool over the last 600 seconds.

The “CHECK” attribute determines a logical frequency at which the condition is re-evaluated based on the values of the variables in the application detection environment. The “CHECK” attribute can have one of two values: “ONSET” or “ON-TIMER”. The “ON-SET” value indicates that the condition is to be checked whenever the “sychron_set_app_variable( )” user API function is called. The “ON-TIMER” value provides for checking the condition at regular intervals (e.g., every ten seconds). If the value is set to “ON-TIMER”, then the frequency is specified (e.g., in seconds). The default value is “ON-TIMER”. Typically, this attribute should only be set to the “ON-SET” value if a low response time is required, and the frequency that the user sets this variable is low.

In the system's presently preferred embodiment, if a policy condition evaluates to a non-zero value (i.e., “true”), then the action is performed depending upon the value of a “WHEN” attribute of the “POLICY-ACTION” clause. Currently, the “WHEN” attribute can have one of two values: “ON-TRANSITION” or “ON-TRUE”. A value of “ON-TRANSITION” provides for the action to be fired when the condition changes from “false” (i.e., a zero value) to “true” (i.e., a non-zero value). If the condition is repeatedly evaluated to “true” after it is already in that state, then the “ON-TRANSITION” value indicates that the action is not to be re-applied. For example, this attribute can be used to give the resources allocated to an application a “boost” when the application's utilization is greater than a specified figure. However, the application is not continually given a boost if its utilization changes, but stays above the pre-defined figure. The “ON-TRUE” value indicates that the action is applied every time the condition is “true”.

The attribute “TIMER” controls an upper bound on the frequency that each action can fire on each server. The optional attribute “ATOMICITY” specifies a time, in seconds, of a maximum frequency that action should be taken on any server in the pool. This is useful if the action has global effect, such as changing the allocation of resources on a server pool-wide basis. Consider, for example, what may happen when the same global condition (e.g., AVERAGE CPU utilization of an application) is evaluated across the four servers. If a policy including this condition is evaluated at four servers it may cause all four servers to fire a request for additional resources. Although the condition indicates that the system should take action to allocate additional resources to the application, allocating an additional server in response to each of the four requests for resources is likely to be inappropriate.

The general approach of the present invention is to make gradual adjustments in response to changing conditions that are detected. Conditions are then reevaluated (e.g., a minute later) to determine if the steps taken are heading in the correct direction. Additional adjustments can then be made as necessary. Broadly, the approach is to quickly evaluate the adjustments (if any) that should be made and make these adjustments in gradual steps. An alternative approach of attempting to calculate an ideal allocation of resources could result in significant processing overhead and delay. Moreover, when the ideal allocation of resources was finally calculated and applied, one may then find that the circumstances have changed significantly while the computations were being performed.

The present invention reacts in an intelligent (and automated) fashion to adjust resource allocations in real time based on changing conditions and based on having some knowledge of global events. Measures are taken to minimize the processing overhead of the system and to enable a user to define policies providing for the system to make gradual adjustments in response to changing conditions. Among these measures that are provided by the system are policy attributes that may be used to dampen the system's response to particular events. For example, when a policy is evaluated at multiple servers based on global variables (e.g., an “AVERAGE” variable), a user may only want to fire a single request to increase resources allocated to the application. An “ATOMICITY” attribute may be associated with this policy to say that the policy will fire an action no more frequently than once every 90 seconds (or similar). Among other reasons that this may be desirable is that it may take some time for a newly allocated resource to come on line and start to have an impact on handling the workload. A user may also define policies in a manner that avoids the system asking the same question over and over again. A user can define how often conditions are to be evaluated (and therefore the cost of performing the evaluation) and also the frequency that action should be taken in response to the condition.

Actions Initiated By Policy

When a policy condition is satisfied, the action associated with the condition is initiated (subject to any attribute or condition that may inhibit the action as described above). A typical action which is taken in response to a condition being satisfied is the execution of an identified program or script (sometimes referred to as “POLICY-SCRIPT”). The script or program to be executed is identified in the policy and should be in a file that is visible from any server (e.g., it is NFS visible from all servers, or replicated in the same location on each server). The policy may also specify arguments that are passed to the program or script when it is executed. If a script action is specified, the script is usually executed with the environment variables “SYCHRON_APPLICATION_NAME” and “SYCHRON_APPLICATION_IO” set to contain the name and 10 of the application whose policy condition was satisfied. Given the application name and 10, the other variables local to the application instance running on the server can be accessed within the script using the command line interface (CLI) tool “sychron_app_variable-get”. However, this may result in a slight race condition between the evaluation of the condition, and reading the variable within the script. To overcome this potential problem, any variable used in the policy also has entries set in the environment passed to the script.

Another action that may be taken is a “POLICY-RESOURCES” action. A “POLICY-RESOURCES” action identifies a change to the allocation of resources to an application that is to be requested when the condition is satisfied. The action may request that the resources allocated to the application be changed by a relative amount (e.g., an extra percentage of available resources for the application), or a fixed value.

A “POLICY-LB” action may also be initiated. A “POLICY-LB” action requests a change to the parameters of an existing load balancing rule (e.g., scheduling algorithm and weights, or type of persistence). It should be noted that new load balancing rules (i.e., rules with a new IP address, port, or protocol) cannot currently be specified as a result of an action fired by a policy. New load balancing rules currently must be added to the default, reference load balancing rules for the application.

Expression Language Terminology

The following lists defined terms provided in the expression language that can be used within policies, resource adjustments, or in connection with the “sychron_get_app_variable( )” CLI tool:
expr:
literal: Constant value
variable: Application variable
−expr: Unary operator (minus)
expr op expr: Binary operator
fun(expr. 1, . . . , expr. n): Function call with n arguments
group (variable [, from, to [,context]]): Group operator on all instance variables
(expr): Bracketed expression
op:
op: +|−|*|/
context:
context: “app-running”|“app-active”
context: “server-running”|“server-active”

The expression language has the basic arithmetic and relational operators plus a series of functions. The functions are split into two classes as follows:
fun: functions that are applied to scalar values such as literals, or the value of a variable on a single server.
group: functions that read all the defined instances of a variable on all servers, and summarize this data using a grouping operator such as “SUM”. If the variable is not defined on any of the servers, then an error is raised.
If the optional “from” and “to” parameters are used, then the period of interest for the variable is the current time minus the “from” seconds, to the current time minus the “to” seconds. For example, “AVERAGE(PercCpuUtilPool, 4200, 3600)” is a rolling ten minutes average CPU utilization from an hour ago.

The following describes the operators and functions currently provided in the expression language:
Group
LO—
CAL: Local variable instance (Note: using “LOCAL( )” with just the variable name is the same as just using the variable. However, with “to” and “from” it allows a way of over-riding the default period of interest used in the conditional.)
AVERAGE: Average of the variables on each server
COUNT: Number of non-zero variable instances
MAX: Largest defined variable instance
MIN: Smallest defined variable instance
SUM: Sum of all variable instances
PRODUCT: Product of all variable instances
Fun
NOT: Negate
IF: Conditional expression
AND: Logical and
OR: Logical or
EQ: Equal to
NE: Not equal
GT: Greater than
GE: Greater than or equal
LT: Less than
LE: Less than or equal
ISSET: 1.0 if a variable is set on this server
NOW: Current date/time
DAY: Return day of month of a date (1-31)
HOUR: Return hour of a date/time (0-23)
MONTH: Return month of a date (1-12)
WEEK—
DAY: Returns 1-7 identifying a day of week (Sunday is one)
SYS-TEM: Executes a command/script and returns the exit code
SYSTEM-VAL: Executes a command/script and returns a number

The group operators take a fourth optional parameter that specifies the subset of the servers within the pool that should have their variable instance involved in the group operator. The default context is “app-running”. For example, the interpretation of “AVERAGE(AbsCpuUtilServer)” is the average CPU utilization on the servers that have running instances of the application with which the policy is associated. If an application is not running on a server during the requested time period, then it does not contribute to the group function. If an application is running at all, then it will contribute as described above in this document (e.g., as though the application ran for the entire requested period).

The default context can be overridden by specifying one of the following contexts: “app-running” (default) including all servers that have a running instance of an application during the requested time period; “app-active” including all servers that have an actively running application (i.e., with respect to the application control described above) during the requested time period; “app-inactive” including all servers that have a running instance that has been deactivated during the requested time period; and “server-running” including all servers that are active in the server pool during the requested time period.

The “SYSTEM( )” function executes a script and returns the exit code of the script. Currently, an exit code of zero is returned on success, and a non-zero exit code is returned in the event of failure (this is the opposite of the logic used for this expression language). The “SYSTEMVAL( )” function executes a script that prints a single numerical value (integer or float) on standard output. The function returns the printed value, which can then be used in the expression language. An error is raised if a numerical value is not returned, or in the event that the exit code from the function is non-zero. The following is an example of a policy condition:

1: <POLICY-CONDITION CHECK=“ON-TIMER”>
2: SYSTEMVAL(“uptime I awk ′/(load) average: / print (NF)‘“) > 1.0
3: </POLICY-CONDITION>

As shown, the above condition is satisfied whenever the server load average is greater than one (1.0).

Server Control and Power Saving

The server pool rules include a section in which the user can specify user-defined commands for “powering off” and “powering on” a server. There is one pair of such commands for each server that the system is requested to power manage. Even if the same scripts are used to perform these operations on different servers, they will take different arguments depending on the specific server that is involved. An example of a server control section of a server pool rule is shown below:

| 1: <SERVER-POOL-RULE NAME=“AcmeServerPool”> | |
|---|---|
| 2: <SERVER-CONTROL> | |
| 3: <SERVER> nodel.acme.com </SERVER> | |
| 4: <SUSPEND-SCRIPT> command-to-power-off-node1 | |
| </SUSPEND-SCRIPT> | |
| 5: <RESUME-SCRIPT> command-to-power-on-node1 | |
| </RESUME-SCRIPT> | |
| 6: </SERVER-CONTROL> | |
| 7: <SERVER-CONTROL> | |
| 8: <SERVER> node2.acme.com </SERVER> | |
| 9: <SUSPEND-SCRIPT> command-to-power-off-node2 | |
| </SUSPEND-SCRIPT> | |
| 10: | <RESUME-SCRIPT> command-to-power-on-node2 |

</RESUME-SCRIPT>
11: </SERVER-CONTROL>
12: ...
13: </SERVER-POOL-RULE>

It should be noted that the command to power off a server will be run on the server itself, whereas the command to power on a server will be run on another server in the pool.

Server Pool Dependent Servers

The “dependent servers” section of a server pool rule is used to specify disjoint server sets whose management is subject to a specific constraint. One type of constraint that is currently supported is “AT-LEAST”. This constraint can be used to specify the minimum number of servers that must remain powered on out of a set of servers. An empty server set can be specified in this section of the server pool rule, to denote all servers not listed explicitly in other dependent server sets. An example of how the dependent servers can be specified is shown below:

```
  1: <SERVER-POOL-RULE NAME=“AcmeServerPool”>
  2: ...
  3: <DEPENDENT-SERVERS NAME=“SPECIAL-SERVERS”
CONSTRAINT= “AT-LEAST”
```

| | |
|---|---|
| 4: | NUM-SERVERS=“I”> |

```
  5: <SERVER> node 19.acme.com < /SERVER>
  6: <SERVER> node34.acme.com </SERVER>
  7: </DEPENDENT-SERVERS>
  8: <DEPENDENT-SERVERS NAME=“ORDINARY-SERVERS”
CONSTRAINT=“AT-LEAST”
```

| | |
|---|---|
| 9: | NUM-SERVERS=“8”> |

10: </SERVER-POOL-RULE>

This example requests that at least one of the “SPECIALSERVERS” node19 and node34 remains powered on at all times. Also, at least eight other servers must be maintained powered on in the server pool.

### Policy Examples

Automated Resource Allocation

The system of the present invention automates resource allocation to optimize the use of resources in the server pool based on the fluctuation in demand for resources. An application rule often specifies the amount of resources to which an application is entitled. These resources may include CPU or memory of servers in the server pool as well as pool-wide resources such as bandwidth or storage. Applications which do not have a policy are entitled only to an equal share of the remaining resources in the server pool.

The system utilizes various operating system facilities and/or third-party products to provide resource control, each providing a different granularity of control. For example, the system can operate in conjunction with Solaris Resource and Bandwidth Manager products on the Solaris environment. In addition, policies can be defined to provide for fine-grained response to particular events. Several examples illustrating these policies will now be described.

Run a Script When CPU Utilization Reaches a Threshold

The following example periodically checks if the CPU utilization of an application instance exceeds 500 MHz:

1: <APPLICATION-POLICY>
2: <POLICY-CONDITION CHECK=“ON-TIMER”>
3: GT(AbsCpuUtilServer, 500)
4: </POLICY-CONDITION>
5: <POLICY-ACTION WHEN=“ON-TRANSITION”>
6: <POLICY-SCRIPT> /var/run/my_script </POLICY-SCRIPT>
7: </POLICY-ACTION>
8: </APPLICATION-POLICY>

As illustrated above, if the CPU utilization of the application instance exceeds 500 MHz, a script is executed. As illustrated at line 5, the action is triggered “ON-TRANSITION”, meaning that the action is triggered (i.e., the script executed) only the first time it goes above the specified value. The script is only re-run if the utilization first falls below 500 MHz before rising again.

Allocating CPU to an Application

If the CPU utilization of an application exceeds the allocation of CPU resources provided under a resource allocation, then the following policy may be activated:

1: <APPLICATION-POLICY>
2: <POLICY-CONDITION CHECK=“ON-TIMER”>
3: GT(AbsCpuUti IPool, AbsCpu Res Pool)
4: </POLICY-CONDITION>
5: <POLICY-ACTION WHEN=“ON-TRANSITION”>
6: < POLICY- RESOURCES TYPE=“ADD” RESOURCE=“CPU”>
7: <POOL-RESOURCES TYPE=“ABSOLUTE”> 1000 </POOL-
RESOURCES>
8: </POLICY-RESOURCES>
9: </POLICY-ACTION>
10: </APPLICATION-POLICY>

As shown, when the CPU utilization of an application exceeds the resources allocated to the application, an extra boost of 1000 MHz is requested. The 1000 MHz increase is only requested “ON-TRANSITION” and not continually. If the “WHEN” attribute is changed from “ON-TRANSITION” to “ON-TRUE”, then the application would continually request additional CPU resources when its utilization was greater than the allocated resources. Generally, a similar policy is also added to the application rule that decrements an amount of resources from the application when the combined CPU utilization falls below a specified value. An appropriate delta value should be added to the condition in both clauses to implement a hysteresis to stop the oscillation between the different rules.

Explicit Congestion Notification Feedback for an MBean

If a policy has an “MBean_PendingRequestCurrentCount” variable that records the current request count of a J2EE instance, then the following rule is triggered on those servers that have a J2EE instance that is running at the maximum capacity of all instances.

1: <APPLICATION-VARIABLES>
2: <VARIABLE>MBean_PendingRequestCurrentCount</VARIABLE>
3: </APPLICATION-VARIABLES>
4:
5: <APPLICATION-POLICY>
6: <POLICY-CONDITION CHECK=“ON-SET”>
7: AND(GT(COUNT(MBean_PendingRequestCurrentCount), 1),
8: EQ(MBean_PendingRequestCurrentCount,
9: MAXIMUM(MBean_PendingRequestCurrentCount)
))
10: </POLICY-CONDITION>
11: <POLICY-ACTION WHEN=“ON-TRANSITION”>
12: <POLICY-SCRIPT> /var/run/ECN_script </POLICY-SCRIPT>
13: </POLICY-ACTION>
14: </APPLICATION-POLICY>

As the “MBean_PendingRequestCurrentCount” variable is not one of the variables set by the system, the policy relies upon code being inserted into the J2EE application. The MBean should set the appropriate variables when the request count becomes non-trivial—there is no point in setting the variable at too fast a frequency. Therefore, in this instance the J2EE application could itself perform hysteresis checking, and only set the variable as it rises above a pre-defined threshold value, and similarly falls below another pre-defined value. Alternatively, the hysteresis can be encoded into two policy conditions as outlined above, but this would involve more checking/overhead in the application rule mechanism.

Redistributing the Resources When the Load is Not Balanced

The following policy ensures that at regular time intervals 500 MHz of CPU are partitioned among the instances of an application in proportion to their actual CPU utilization:

1: <APPLICATION-POLICY>
2: <POLICY-CONDITION CHECK=“ON-TIMER”>
3: NE(AbsCpuUtilServer * 500 / SUM(AbsCpuUtilServer),
4: AbsCpuReqResServer)
5: </POLICY-CONDITION>
6: <POLICY-ACTION WHEN=“ON-TRUE”>
7: <POLICY-RESOURCES TYPE=“SET” RESOURCE=“CPU”>
8: <SERVER-RESOURCES>
<RESOURCE-VALUE TYPE=“ABSOLUTE”
RANGE=“REQUESTED”>
9: AbsCpuUtilServer * 500 / SUM(AbsCpuUtilServer) </RESOURCE-
VALUE>
10: </SERVER-RESOURCES>
11: </POLICY-RESOURCES>
12: </POLICY-ACTION>
13: </APPLICATION-POLICY>

In a normal usage situation, the condition will typically be set so that the policy fires if the ideal resources of an instance is outside the range of the “AbsCpuReqResServer” plus or minus 5% (or similar).

Load Balancing

In order to increase application headroom while simultaneously improving server utilization, a customer may run multiple instances of an application on multiple servers. Many mission-critical applications are already configured this way by a user for reasons of high-availability and scalability. Applications distributed in this way typically exploit third-party load balancing technology to forward requests between their instances. The system of the present invention integrates with such external load balancers to optimize the allocation of resources between applications in a pool, and to respect any session “stickiness” the applications require. The system's load balancer component can be used to control hardware load balancers such as F5's Big-IP or Cisco's 417 LocalDirector, as well as software load balancers such as Linux LVS.

The system of the present invention can be used to control a third-party load balancing switch, using the API made available by the switch, to direct traffic based on the global information accumulated by the system about the state of servers and applications in the data center. The system frequently exchanges information between its agents at each of the servers in the server pool (i.e., data center) about the resource utilization of the instances of applications that require load balancing. These information exchanges enable the system to adjust the configuration of the load balancer in real-time in order to optimize resource utilization within the server pool. Third-party load balancers can be controlled to enable the balancing of client connections within server pools. The load balancer is given information about server and application instance loads, together with updates on servers joining or leaving a server pool. The user is able to specify the load balancing method to be used in conjunction with an application from the wide range of methods which are currently supported.

The functionality of the load balancer will automatically allow any session “stickiness” or server affinity of the applications to be preserved, and also allow load balancing which can differentiate separate client connections which originate from the same source IP address. The system uses the application rules to determine when an application instance, which requires load balancing, starts or ends. The application rules place application components (e.g., processes and flows), which are deemed to be related, into the same application. The application then serves as the basis for load balancing client connections. The F5 Big-IP switch, for example, can set up load balancing pools based on lists of both IP addresses and port numbers, which map directly to a particular application defined by the system of the present invention.

This application state is exchanged with the switch, together with information concerning the current load associated both with application instances and servers, allowing the switch to load balance connections using a weighted method which is based on up-to-date load information. The system of the present invention also enables overloaded application instances to be temporarily removed from the switch's load balancing tables until its state improves. Some load balancing switches (e.g., F5's Big-IP switch) support this functionality directly. When a hardware load balancer is not present, a basic software-based load balancing functionality may be provided by the system (e.g., for the Solaris and Linux Advanced Server platforms).

Default Application Load Balancing

The default (or reference) load balancing section of an application rule specifies the reference load balancing that the system should initially establish for a given application. The reference load balancing rules are typically applied immediately when:
The application is first detected by the system.
A rule for a new service IP address and/or port and/or protocol is set by changing the application policy of an existing application.
An existing rule (i.e., a rule corresponding to a well-defined IP address and/or port and/or protocol) is removed by changing the application policy of an existing application.
An existing rule (i.e., a rule corresponding to a well-defined IP address and/or port and/or protocol) is modified, and the parameters of this rule have not been changed from their default, reference value by a policy.

In the case where the parameters of an existing policy (e.g., scheduling algorithm and weights, or type of persistence) were changed from their reference values by a policy action, then the changes to the default load balancing rule are applied at a later time, when another policy requests that the reference values to be reinstated. An example of a default load balancing specification (e.g., as a portion of the application policy for the sample WebServer application) is given below:

1: ...
2: <LB-RULE IP=“10.2.1.99” PORT=“80” PROTOCOL=“TCP”>
3: <LB-PARAMS METHOD=“Linux-AS”>
4: <SCHEDULER>
5: <TYPE>Least connections</TYPE>
6: </SCHEDULER>
7: </LB-PARAMS>
8: <LB-PARAMS METHOD=“BigIP-520”>
9: <SCHEDULER>
10: <TYPE>Round robin</TYPE>
11: </SCHEDULER>
12: <STICKINESS>
13: <TYPE>SSL</TYPE>
14: <TIMEOUT>1800</TIMEOUT>
15: </STICKENESS>
16: </LB-PARAMS>
17: </LB-RULE>
18: ...

Application Rule for the Sample “WebServer” Application

The following complete application rule of the sample “WebServer” application consolidates the application rule sections used above in this document:

1: <APPLICATION-RULE NAME=“WebServer” BUSINESS-
PRIORITY=“100” POWER-SAVING=“NO”>
2:
3: <APPLICATION-DEFINITION>
4: <PROCESS-RULES>
5: <PROCESS-RULE INCLUDE-CHILD-PROCESSES=“YES”>
6: <PROCESS-NAME>httpd</PROCESS-NAME>
7: </PROCESS-RULE>
8: </PROCESS-RULES>
9: <FLOW-RULES>
10: <FLOW-RULE>
11: <LOCAL-PORT>80</LOCAL-PORT>
12: </FLOW-RULE>
13: </FLOW-RULES>
14: </APPLICATION-DEFINITION>
15:
16: <DEFAULT-RESOURCES RESOURCE=“CPU”>
17: <POOL-RESOURCES TYPE=“ABSOLUTE”> 5000 </POOL-
RESOURCES>
18: <SERVER-RESOURCES>
19: <RESOURCE-VALUE RANGE=“REQUESTED” TYPE=“
ABSOLUTE”> 750 </RESOURCE-VALUE>
20: </SERVER-RESOURCES>
21: </DEFAULT-RESOURCES>
22:
23: <LB-RULE IP=“10.2.1.99” PORT=“80” PROTOCOL=“TCP”>
24: <LB-PARAMS METHOD=“Linux-AS”>
25: <SCHEDULER>
26: <TYPE>Least connections</TYPE>
27: </SCHEDULER>
28: </LB-PARAMS>
29: <LB-PARAMS METHOD=“BigIP-520”>
30: <SCHEDULER>
31: <TYPE>Round robin</TYPE>
32: </SCHEDULER>
33: <STICKINESS>
34: <TYPE>SSL</TYPE>
35: <TIMEOUT>1800</TIMEOUT>
36: </STICKINESS>
37: </LB-PARAMS>
38: </LB-RULE>
39:
40: <SERVER-INVENTORY>
41: <SUSPEND-RESUME-SERVERS>
42: <SERVER> node19.acme.com </SERVER>
43: <SERVER> node20.acme.com </SERVER>
44: <SERVER> node34.acme.com </SERVER>
45: </SUSPEND-RESUME-SERVERS>
46:
47: <DEPENDENT-SERVERS NAME=“PRIMARY-BACKUP-
SERVERS”CONSTRAINT=“TOGETHER”>
48: <SERVER> node19.acme.com </SERVER>
49: <SERVER> node34.acme.com </SERVER>
50: </DEPENDENT-SERVERS>
51: </SERVER-INVENTORY>
52:
53: <APPLICATION-CONTROL>
54: <SUSPEND-SCRIPT> /etc/init.d/httpd stop</SUSPEND-
SCRIPT>
55: <RESUME-SCRIPT>/etc/init.d/httpd start</RESUME-SCRIPT>
56: </APPLICATION-CONTROL>
57:
58: <APPLICATION-POLICY EVAL-PERIOD=“10”>
59: <POLICY-CONDITION CHECK=“ON-TIMER” TIMER=“10”>
60: GT(PercCpuUtilPool, 10)
61: </POLICY-CONDITION>
62: <POLICY-ACTION WHEN=“ON-TRANSITION”
ATOMICITY=“60”>
63: <POLICY- SCRIPT> /var/ ru n/ my_scri pt< / POLICY-
SCRIPT>
64: </POLICY-ACTION>
65: </APPLICATION-POLICY>
66:
67: <APPLICATION-POLICY>
68: <POLICY-CONDITION CHECK=“ON-TIMER”>
69: GT(AbsCpuUtilPool, AbsCpuResPool)
70: </POLICY-CONDITION>
71: <POLICY-ACTION WHEN=“ON-TRANSITION”>
72: <POLICY-RESOURCES TYPE=“ADD” RESOURCE=“CPU”>
73: <POOL-RESOURCES TYPE=“ABSOLUTE”> 1000 </
POOL-RESOURCES>
74: </POLICY-RESOURCES>
75: </POLICY-ACTION>
76: </APPLICATION-POLICY>
77:
78: </APPLICATION-RULE>

Intelligent Load Balancing Control

“Weighted” scheduling algorithms such as “weighted round robin” or “weighted least connections” are supported by many load balancers, and allow the system to intelligently control the load balancing of an application. This functionality can be accessed by specifying a weighted load balancing algorithm in the application rule, and an expression for the weight to be used. The system will evaluate this expression, and set the appropriate weights for each server on which the application is active. The expressions used for the weights can include built-in system variables as well as user-defined variables, similar to the expressions used in policies (as described above).

The following example load balancing rule specifies weights that are proportional to the CPU power of the servers involved in the load balancing:

1: <LB-RULE IP=“10.2.1.99” PORT=“80” PROTOCOL=“TCP”>
2: <LB-PARAMS METHOD=“Linux-AS”>
3: <SCHEDULER>
4: <TYPE>Weighted round robin</TYPE>
5: <WEIGHT>AbsCpuServer</WEIGHT>
6: </SCHEDULER>
7: </LB-PARAMS>
8: </LB-RULE>

Another useful expression is to set the weights to a value proportional to the CPU headroom of the servers on which the application is active as illustrated in the following example load balancing rule:

1: <LB-RULE IP=“10.2.1.99” PORT=“80” PROTOCOL=“TCP”>
2: <LB-PARAMS METHOD=“Linux-AS”>
3: <SCHEDULER>
4: <TYPE>Weighted round robin</TYPE>
5: <WEIGHT EVAL-PERIOD=“60”>AbsCpuHeadroomServer
</WEIGHT>
6: </SCHEDULER>
7: </LB-PARAMS>
8: </LB-RULE>

In the above rule, the weights are set to a value equal to the average CPU headroom of each server over the last 60 seconds when the default load balancing is initiated. It should be noted that the above expressions are not reevaluated periodically; however, a policy can be used to achieve this functionality if desired.

Enforcement of Application Policies

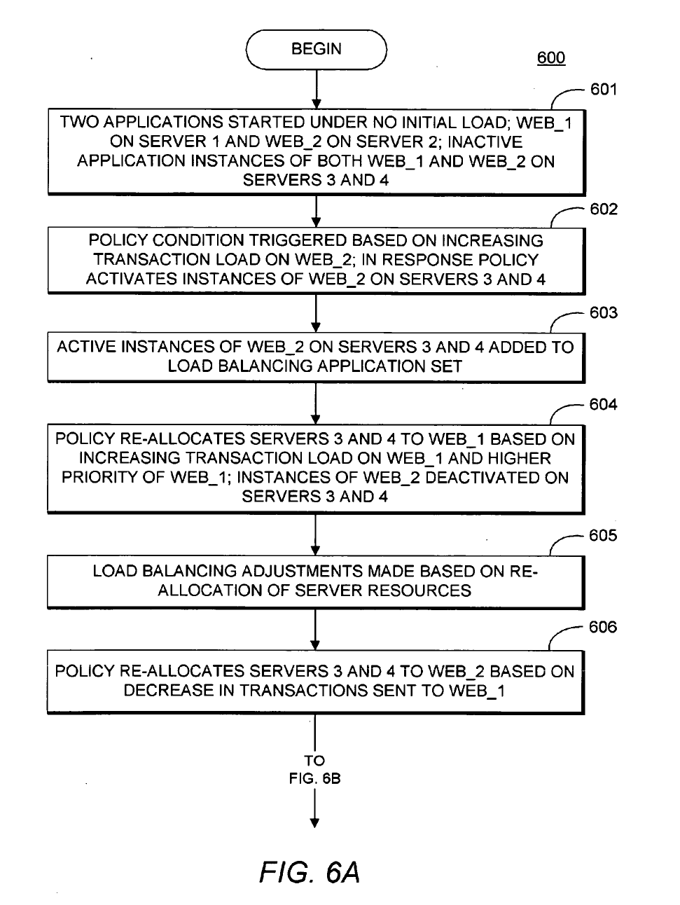

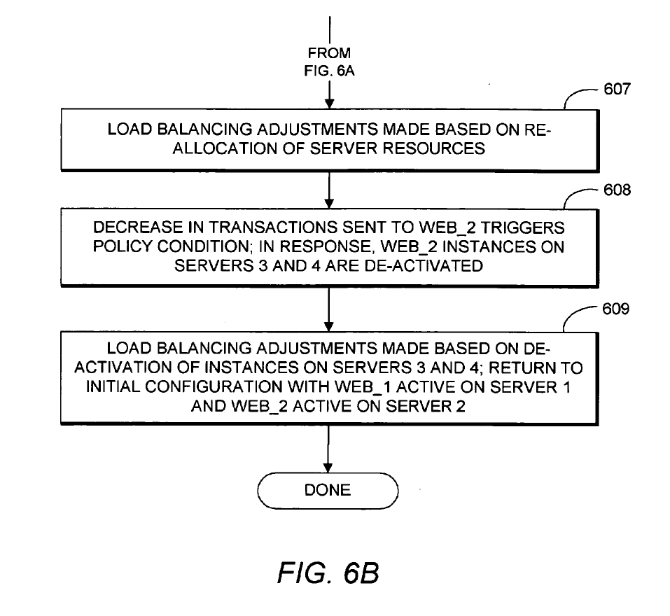

FIGS. 6A-B comprise a single flowchart 600 illustrating an example of the system of the present invention applying application policies to allocate resources amongst two applications. The following description presents method steps that may be implemented using processor-executable instructions, for directing operation of a device under processor control. The processor-executable instructions may be stored on a computer-readable medium, such as CD, DVD, flash memory, or the like. The processor-executable instructions may also be stored as a set of downloadable processor-executable instructions, for example, for downloading and installation from an Internet location (e.g., Web server).

The following discussion uses an example of a simple usage scenario in which the system is used to allocate resources to two applications running in a small server pool consisting of four servers. The present invention may be used in a wide range of different environments, including much larger data center environments involving a large number of applications and servers. Accordingly, the following example is intended to illustrate the operations of the present invention and not for purposes of limiting the scope of the invention.

In this example, two Web applications are running within a pool of four servers that are managed by the system of the present invention. Each application is installed, configured, and running on three of the four servers in the pool. More particularly, server 1 runs the first application (Web_{—}1), server 2 runs the second application (Web_{—}2), and servers 3 and 4 run both applications. The two Web applications are also configured to accept transactions on two different (load balanced) service IP address:port pairs. In addition, the two applications have different business priorities (i.e., Web_{—}1 has a higher priority than Web_{—}2).

The following discussion assumes that the environment is configured as described above and that both applications have pre-existing application rules that have been defined. These rules specify default (reference) resources that request a small amount of (CPU) resources when the applications are initially detected by the system. They also have policies that periodically update the CPU power requested from the system based on the actual CPU utilization over the last few minutes. As traffic into either or both of these Web applications increases (and decreases), these established policies will update their CPU power requirements (e.g., request additional CPU resources), and the allocation of server resources to the applications will be adjusted based on the policy as described below.

The two Web applications initially are started with no load, so there is one active instance for each of the applications (e.g., Web_{—}1 on server 1 and Web_{—}2 on server 2). As the application rules provide for small initial resource allocations, at step 601 each of the applications are allocated one server where they are “activated”, i.e., added to the load balanced set of application instances for the two service IP address:port pairs (e.g., Web_{—}1 on server 1 and Web_{—}2 on server 2). In this situation, servers 3 and 4 have only inactive application instances running on them. In other words, each of the applications will initially have one active instance to which transactions are sent, and two inactive instances that do not handle transactions.

Subsequently, an increasing number of transactions are received and sent to the lower priority application (Web_{—}2). At step 602, this increasing transaction load triggers a policy condition which causes the Web_{—}2 application to request additional resources. In response, the system takes the necessary action to cause instances of the Web_{—}2 application to become active first on two servers (e.g., on servers 2 and 3), and then on three servers (e.g., servers 2, 3, and 4). It should be noted that the increased resources allocated to this application may result from one or more policy conditions being satisfied. At step 603, the active application instances on servers 3 and 4 will also typically be added to the load balancing application set. Each time additional resources (e.g., a new server) is allocated to Web_{—}2, the response time/number of transactions per second/latency for Web_{—}2 improves.

Subsequently, an increasing number of transactions maybe sent to the higher priority Web_{—}1 application. At step 604, this increasing transaction load causes the system of the present invention to re-allocate servers to Web_{—}1 (e.g., to allocate servers 3 and 4 to Web_{—}1 based on a policy applicable to Web_{—}1). As a result, instances of the lower priority Web_{—}2 application are de-activated on servers 3 and 4. It should be noted that the resources are taken from the lower-priority Web_{—}2 application even though the traffic for the lower priority application has not decreased. At step 605, the appropriate load-balancing adjustments are also made based on the re-allocation of server resources. As a result of these actions, the higher priority Web_{—}1 application obtains additional resources (e.g., use of servers 3 and 4) and is able to perform better (in terms of response time, number of transactions per second, etc.). However, the lower priority Web_{—}2 application performs worse than it did previously as its resources are re-allocated to the higher priority application (Web_{—}1).

When the number of client transactions sent to the higher priority application (Web_{—}1) decreases, at step 606 another condition of a policy causes the higher priority application to release resources that it no longer needs. In response, the system will cause resources allocated to Web_{—}1 to be released. Assuming Web_{—}2 still has a high transaction load, these resources (e.g., servers 3 and 4) will then again be made available to Web_{—}2. If the transaction load on Web_{—}1 drops significantly, instances of Web_{—}2 may be activated and running on three of the four servers. At step 607, the corresponding load balancing adjustments are also made based on the change in allocation of server resources.

Subsequently, the number of client transactions sent to Web_{—}2 may also decrease. In response, at step 608 a policy causes Web_{—}2 to release resources (e.g., to de-activate the instances running on servers 3 and 4). At step 609, the same condition causes the system to make load balancing adjustments. As a result, the initial configuration in which each of the applications is running on a single server may be re-established. The system will then listen for subsequent events that may cause resource allocations to be adjusted.

The annotated application rules supporting the above described usage case are presented below for both the “Web_{—}1” and “Web_{—}2” applications. The following is the annotated application rule for the higher-priority “Web_{—}1” application:

1: <APPLICATION-RULE NAME=“Web_1” BUSINESS-PRIORITY=
“10” POWER-SAVING=“NO”>
2: <APPLICATION-DEFINITION>
3: <PROCESS-RULES>
4: <PROCESS-RULE INCLUDE-CHILD-PROCESSES=“YES”>
5: <CMDLINE>[A!l+ /httpd_I.conf</CMDLINE>
6: </PROCESS-RULE>
7: </PROCESS-RULES>
8:
9: <FLOW-RULES>
10: <FLOW-RULE>
11: <LOCAL-PORT>8081</LOCAL-PORT>
12: </FLOW-RULE>
13: </FLOW-RULES>
14: </APPLICATION-DEFINITION>
15:
16: <DEFAULT-RESOURCES RESOURCE=“CPU”>
17: <POOL-RESOURCES TYPE=“ABSOLUTE”>
18: 100
19: </POOL-RESOURCES>
20: </DEFAULT-RESOURCES>
21:
22: <LB-RULE IP=“10.1.254.169” PORT=“8081”
PROTOCOL=“TCP”>
23: <LB-PARAMS METHOD=“BigIP-520”>
24: <SCHEDULER>
25: <TYPE>Round-robin</TYPE>
26: </SCHEDULER>
27: <STICKINESS>
28: <TYPE>None</TYPE>
29: </STICKINESS>
30: </LB-PARAMS>
31: </LB-RULE>
32:
33: <APPLICATION-POLICY NAME=“SetResources”
EVAL-PERIOD=“60”>
34: <POLICY-CONDITION CHECK=“ON-TIMER”
TIMER=“60”>
35: AND(
36: OR(
37: LT(SUM(AbsCpuUtilServer),0.4*ReqAbsCpuRes
Pool),
38: GT(SUM(AbsCpuUtilServer),0.6*ReqAbsCpuResPool)),
39: GT(ABS(SUM(AbsCpuUtilServer,120,60) -
SUM(AbsCpuUtilServer,60,0)),100))
40: </POLICY-CONDITION>
41: <POLICY-ACTION WHEN=“ON-TRUE”>
42: <POLICY-RESOURCES TYPE=“SET” RESOURCE=“CPU”>
43: <POOL-RESOURCES TYPE=“ABSOLUTE”>
44: 2*SUM(AbsCpuUtilServer)+ 10
45: </POOL-RESOURCES>
46: </POLICY-RESOURCES>
47: </POLICY-ACTION>
48: </APPLICATION-POLICY>
49:
50: <APPLICATION-POLICY NAME=“Active”>
51: <POLICY-CONDITION CHECK=“ON-TIMER”>
52: LOCAL(Active,0,0)
53: </POLICY-CONDITION>
54: <POLICY-ACTION WHEN=“ON-TRANSITION”>
55: <POLICY-SCRIPT>
56: /opt/svchron/tests/jabber_event--subject ‘*** Application is
now active ***’ --user webmaster@jabber.sychron.com
57: </POLICY-SCRIPT>
58: </POLICY-ACTION>
59: </APPLICATION-POLICY>
60:
61: <APPLICATION-POLICY NAME=“Inactive”>
62: <POLICY-CONDITION CHECK=“ON-TIMER”>
63: NOT(LOCAL(Active,O,O))
64: </POLICY-CONDITION>
65: <POLICY-ACTION WHEN=“ON-TRANSITION”>
66: <POLICY-SCRIPT>
67: /opt/sychron/tests/jabber_event--subject ‘*** Application
is now inactive ***’ --user webmaster@jabber.sychron.com
68: </POLICY-SCRIPT>
60: </POLICY-ACTION>
70: </APPLICATION-POLICY>
71:
72: </APPLICATION-RULE>

As provided at line 1, the first application is named “Web_{—}1” and has a priority of 10. The processes and network traffic for the application are defined commencing at line 2 (“APPLICATION-DEFINITION”). Line 3 introduces the section that specifies the processes belonging to the application. The first rule for identifying processes belonging to the application (and whose child processes also belong to the application) commences at line 4. At line 5, the process command line must include the string “httpd_{—}1.conf”, which is the configuration file for the first application. The flow rules for associating network traffic with certain characteristics to the application commence at line 9. At line 11, the first rule for identifying network traffic belonging to the application provides that network traffic for port 8081 on any server in the Sychron-managed pool belongs to this application.

The default CPU resources defined for this application commence at line 16. The “POOL” CPU resources are those resources that all instances of the application taken together require as a default. Line 17 provides that the resources are expressed in absolute units, i.e., in MHz. Line 18 indicates that the application requires 100 MHz of CPU as a default.

A load balancing rule is illustrated commencing at line 22. Client requests for this application are coming to the load balanced IP address 10.1.254.169, on TCP port 8081. The system will program the Big-IP-520 F5 external load balancer to load balance these requests among the active instances of the application. The scheduling method to be used by the load balancer is specified in the section commencing at line 24. Round robin load balancing is specified at line 25. The stickiness method to be used by the load balancer is also specified in this section. As provided at line 28, no stickiness of connections must be used.

A policy called “SetResources” commences at line 33. The built-in system state variables used in the policy are evaluated over a 60-second time period (i.e., the last 60 seconds). As provided at line 34, the policy condition is evaluated every 60 seconds. The policy condition evaluates to TRUE if two sub-conditions are TRUE. At lines 36-38, the first sub-condition requires that either the CPU utilization of the application SUMmed across all its instances is under 0.4 times the CPU resources allocated to the application OR the CPU utilization of the application SUMmed across all its instances exceeds 0.6 times the CPU resources allocated to the application. At line 39, the second subcondition requires that the CPU utilizations of the application calculated for the last minute and for the minute previous to the last minute, and SUMmed across all its instances, differ by at least 100 MHz.

The policy action that is performed based on evaluation of the above condition commences at line 41. As provided at line 41, the action will be performed each time when the above condition evaluates to TRUE. The policy action sets new requested resource values for the application as provided at line 42. The modified resource is the CPU power requested for the application. As provided at line 43, the CPU resources that all instances of the application taken together require are expressed in absolute units, i.e., in MHz. The new required CPU resources for the application based on the activation of this policy are twice the CPU utilization of the application SUMmed cross all its instances plus 10 MHz. (The 10 MHz ensure that the application is left with some minimum amount of resources even when idle.)

Another policy called “Active” starts at line 50. The policy condition is also evaluated periodically, with the default period of the policy engine. Line 52 provides that the policy condition evaluates to TRUE if the application has an active instance on the local server at the evaluation time. The policy action is performed “ON-TRANSITION” as provided at line 54. This means that the action is performed each time the policy condition changes from FALSE during the previous evaluation to TRUE during the current evaluation. A script is run when the policy action is performed. As illustrated at line 56, the script sends a jabber message to the user ‘webmaster’ from Sychron, telling him/her that the application is active on the server. Notice that the name of the server and the name of the application are included in the message header implicitly.

Another policy called “Inactive” commences at line 61. The policy condition is evaluated periodically, with the default period of the policy engine. The policy condition evaluates to TRUE if the application does not have an active instance on the local server at the evaluation time as provided at line 63. As with the above “Active” policy, this “Inactive” policy takes action “ON-TRANSITION”. A script is also run when the policy action is performed as provided at line 67. The script sends a jabber message to the user ‘webmaster’ from Sychron, telling him/her that the application is inactive on the server. The name of the server and of the application are again included in the message header implicitly.

The following is the annotated application rule for the lower-priority “Web_{—}2” application:

1: <APPLICATION-RULE NAME=“Web_2” BUSINESS-
PRIORITY=“5” POWER-SAVING=“NO”>
2: <APPLICATION-DEFINITION>
3: <PROCESS-RULES>
4: <PROCESS-RULE INCLUDE-CHILD-PROCESSES=“YES”>
5: <CMDLINE>[A!l+ /httpd_2.conf</CMDLINE>
6: </PROCESS-RULE>
7: </PROCESS-RULES>
8:
9: <FLOW-RULES>
10: <FLOW-RULE>
11: <LOCAL-PORT>8082 </LOCAL-PORT>
12: </FLOW-RULE>
13: </FLOW-RULES>
14: </APPLICATION-DEFINITION>
15:
16: <DEFAULT-RESOURCES RESOURCE=“CPU”>
17: <POOL-RESOURCES TYPE=“ABSOLUTE”>
18: 100
19: </POOL-RESOURCES>
20: </DEFAULT-RESOURCES>
21:
22: <LB-RULE IP=“10.1.254.170” PORT=“8082”
PROTOCOL=“TCP”>
23: <LB-PARAMS METHOD=“BigIP-520”>
24: <SCHEDULER>
25: <TYPE>Round-robin</TYPE>
26: </SCHEDULER>
27: <STICKINESS>
28: <TYPE>None</TYPE>
29: </STICKINESS>
30: </LB-PARAMS>
31: </LB-RULE>
32:
33: <APPLICATION-POLICY NAME=“SetResources”
EVAL-PERIOD=“60”>
34: <POLICY-CONDITION CHECK=“ON-TIMER” TIMER=“60”>
35: AND(
36: OR(
37: LT(SUM(AbsCpuUtilServer),0.4*ReqAbsCpuRes Pool),
38: GT(SUM(AbsCpuUtilServer),0.6*ReqAbsCpuResPool)),
39: GT(ABS(SUM(AbsCpuUtilServer,120,60) -
SUM(AbsCpuUtilServer,60,0)),100))
40: </POLICY-CONDITION>
41: <POLICY-ACTION WHEN=“ON-TRUE”>
42: <POLICY-RESOURCES TYPE=“SET” RESOURCE=“CPU”>
43: <POOL-RESOURCES TYPE=“ABSOLUTE”>
44: 2*SUM(AbsCpuUtilServer)+10
45: </POOL-RESOURCES>
46: </POLICY-RESOURCES>
47: </POLICY-ACTION>
48: </APPLICATION-POLICY>
49:
50: <APPLICATION-POLICY NAME=“Active”>
51: <POLICY-CONDITION CHECK=“ON-TIMER”>
52: LOCAL(Active,0,0)
53: </POLICY-CONDITION>
54: <POLICY-ACTION WHEN=“ON-TRANSITION”>
55: <POLICY-SCRIPT>
56: /opt/svchron/tests/jabber_event--subject ‘*** Application
is now active ***’ --user webmaster@jabber.sychron.com
57: </POLICY-SCRIPT>
58: </POLICY-ACTION>
59: </APPLICATION-POLICY>
60:
61: <APPLICATION-POLICY NAME=“Inactive”>
62: <POLICY-CONDITION CHECK=“ON-TIMER”>
63: NOT(LOCAL(Active,0,0))
64: </POLICY-CONDITION>
65: <POLICY-ACTION WHEN=“ON-TRANSITION”>
66: <POLICY-SCRIPT>
67: /opt/sychron/tests/jabber_event--subject ‘*** Application is
now inactive ***’ --user webmaster@jabber.sychron.com
68: </POLICY-SCRIPT>
60: </POLICY-ACTION>
70: </APPLICATION-POLICY>
71:
72: </APPLICATION-RULE>

The above application policy for “Web_{—}2” is very similar to that of “Web_{—}1” (i.e., the first application with the policy described above). As provided at line 1, the second application is named “Web_{—}2” and has a priority of 5. The processes and network traffic for the application are defined commencing at line 2 (“APPLICATION-DEFINITION”). This rule is similar to that specified for the first application. However, at line 5, this rule indicates that the process command line must include the string “httpd_{—}2.conf”, which is the configuration file for the second application. The flow rules for associating network traffic with certain characteristics to the application commence at line 9 and provide that network traffic for port 8082 on any server in the managed pool belongs to this second application (i.e., Web_{—}2).

The default CPU resources defined for the second application commence at line 16. The second application requires an absolute value of 100 MHz of CPU as a default (this is the same as the first application).

This application rule also includes a load balancing rule. As provided at line 22, client requests for this application are coming to the load balanced IP address 10.1.254.170, on TCP port 8082. The system will program an external load balancer to load balance these requests among the active instances of the application. A round robin load balancing method is specified at line 25. No stickiness of connections is required for load balancing of Web_{—}2.

The application rule for this second application also includes a policy called “SetResources” which commences at line 33. This policy includes the same condition and subconditions as with “SetResources” policy defined for the first application. The policy action that is performed based on the condition commences at line 41. This action is also the same as that described above for the first application. The “Active” policy commencing at line 50 and the “Inactive” policy commencing at line 61 are also the same as the corresponding policies of the first application (Web_{—}1).

Many of the policies of the two applications illustrated above are the same or very similar. However, typical “real world” usage situations will generally have a larger number of applications and servers and each of the applications is likely to have an application rule that is quite different than those of other applications. Additional details about how these policies are realized will next be described.

Policy Realization

The following discussion presents a policy realization component of the system of the present invention. Depending on their type, application policies are evaluated either at regular time intervals (“ON-TIMER”), or when the user-defined variables used in the policy conditions change their values (“ON-SET”). The following code fragment illustrates a policy realization component for the periodic evaluation of “ON-TIMER” policies:

1: \begin{code} *&*/
2: static void swm_policies_check_on_timer(void *dummy){
3:
4: if (operation_mode != SWM_HALT_MODE) {
5: sychron_evaLbuiltin_flush_cache(lua_state);
6:
7: swm_ru_les_app_iterator(1swm_policies_check_for_one_app);
8: }
9:
10: policy_check_step++;
11:
12: return;
13:
14: }
15: /*&* \end{code}

The policy conditions are checked at regular intervals. When it is time for the conditions to be checked, the above function is called (e.g., an “SWM” or Sychron Workload Manager component calls this function). The function first flushes all cached built-in variables as provided at line 5 (from “lua”) and then iterates through the active applications, checking the policies for each application in turn.

The following code segment is called by the application iterator for a single application to evaluate the policy conditions for the application and decide if any action needs to be taken:

1: \begin{code} *&*/
2: static void lswm_policies_check_for_one_app
3: (swm_app_id_t app_id, int rule_ind) {
4:
5: swm_policy_t *policy = NULL;
6: syc_uint32_t i, step_freq;
7: swm_cause_t cause = {“ON-TIMER policy”, 0.0};
8:
9: /*-- 1. iterate through all policies for this rule --*/
10: for (i = 0; i < rule_set->rules[rule_ind].policies.npolicies;i++) {
11: policy = &rule_set->rules[rule_ind].policies.policy[i]
12: /*-- la. only consider the desired policies --*/
13: if (policy->condition.check ==
SWM_POLICY_CHECK_ON_TIMER)
{
14: step_freq =
15: policy->condition.timer?
16: ((policy->condition.timer + swm_policies_time_interval − 1)
/
17: swm_policies_time_interval):
18: SWM_POLICY_CONDITION_DEFAULT_FREQUENCY;
19:
20: if ((policy_check_step %step_freq) == 0)
21: lswm_policies_condition_action(app_id, ru le_ind, i,policy,
22: policy->condition.timer,”“,&cause);z
23: }
24: }
25:
26: return;
27:
28: }
29: /*&* \end{code}

It should be noted that when the “lua evaluator” is called, the system checks the period for any built-in variable calculations, supplies any changed variables, and reconstructs the function name for the condition.

The next block of code ensures the one-off evaluation of “ON-SET” policies (i.e., policies evaluated when a user-defined variable used in the policy condition changes its value):

1: \begin{code} *&*/
2: static int lswm_policies_variable_set(swm_app_id_t app_id,
3: char *variable,
4: double value,
5: int ru le_ind) {
6:
7: swm_policies_t *policies = &rule_set->rules[rule_ind].
policies;
8: swm_policy_t *policy;
9: syc_uint32_t i;
10: int err, any_err = 0;
11: swm_cause_t cause;
12:
13: /*-- 0. Initialise cause --*/
14: cause.name = variable;
15: cause.value = value;
16:
17: /*-- 1. iterate through policies for this app --*/
18: for (i = 0; i < policies->npolicies; i++) {
19: policy = &policies->policy[i];
20: if (policy->condition.check ==
SWM_POLICY_CHECK_ON_SET) {
21: err = lswm_policies_condition_action(app_id,rule_ind,i,
22: policy,0,var iable,&cause);
23: if (err)
24: any_err = err;
25: }
26: }
27:
28: return any_err;
29:
30: }
31: /*&* \end{code}

When an application variable is set for an application, all policy conditions for the application that are of type “evaluate on set” are evaluated. As shown, the above routine iterates through the policy conditions for the application.

The actual evaluation of the policy is done by the function below, which is executed when required for both “ON-TIMER” and “ON-SET” policies:

1: \begin{code} *&*/
2: static int lswm_policies_condition_action(swm_app_id_tapp_id,
3: int rule_ind,

| | |
|---|---|
| 4: syc_uint32_t | cond_ind, |
| 5: swm_policy_t | *policy, |
| 6: syc_uint32_t | timer, |
| 7: const char | *variable, |

8: const swm_cause_t *cause) {
9:
10: int res = 0;
11: char *name = NULL;
12: syc_uint32_t period, flags;
13: const char *lua_result = NULL;
14: sychron_eva l_transition_t trans_result = no_evaluation;
15: double eval_result;
16: time_t atomicity_keepout = policy->action.atomicity;
17:
18: /* Do not evaluate the policy if the action has happened
recently * /
19: if (policy->action.atomicity &&
20: !lswm_pol icies_atomicity_maybe_ok(app_id, ru le_ind,
cond_i nd,
21: atomicity_keepout))
22: return 0;
23:
24: period = policy->eval_period ?
25: policy->eval_period:
SWM_VARIABLES_BUILT_IN_DEFAULT_PERIOD;
26. name = lswm_make_lua_name(rule_ind, cond_ind, 1);
27: if (name) {
28: flags = SYCHRON_EVAL_FLAGS_LOGGING;
29: if (policy->action.when ==
SWM_POLICY_ON_TRANSITION) {
30: flags 1= SYCHRON_EVAL_FLAGS_TRANSITION;
31: }
32: lua_result = sychron_eval_function(lua_state, name, app_id,
33: period, timer, variable, flags,
34: &evaLresult, &trans_result);
35:
36: /*-- if result matches policy specification take action --*/
37: if (lua_result) {
38: slog_msg(SLOG_DEBUG, “Error evaluating policy
expression”
39: “[lswm_policies_variable_set( ): %s]”
40: “APP ID %d EXPRESSION INDEX %d”,
41: lua_result, (int)app_id, cond_ind);
42: res = −1;
43: }
44: else {
45: if ((policy->action.when = = SWM_POLICY_ON_TRUE &&
46: eval_result != 0.0) ||
47: (policy->action.when ==
SWM_POLICY_ON_TRANSITION &&
48: trans_result == transition_to_true)) {
49: /* Only evaluate policy if the action has not happened
recently */
50: if (!policy->action.atomicity ||
51: lswm_policies_atomicity_commit
(app_id,rule_ind, cond_ind,
52: atomicity_keepout))
53: lswm_policies_perform_action(app_id, rule_ind,
cond_ind,
54: evaLresult, cause);
55: }
56: }
57: }
58: else {
59: slog_msg(SLOG_WARNING, “Error creating expression
name”
60: “[lswm_policies_variable_set( )]”
61: “APP ID %d EXPRESSION INDEX %d”, (int)app_id, cond_ind);
62: res = −1;
63: }
64: /* free memory allocated for name */
65: free(name);
66:
67: return res;
68:
69: }
70: /*&* \end{code

The above function checks an “atomicity” attribute to determine if the action has recently occurred. If the action has not recently occurred, then the policy condition is evaluated. If the policy condition is satisfied, the corresponding action provided in the policy is initiated (if necessary). The function returns zero on success, and a negative value in the event of error.

The action component of a policy that “fires” the performance of an action is handled by the following code fragment:

1: \begin{code} *&*/
2: static void lswm_policies_perform_action(swm_app_id_t
app_id,
3: int rule_ind,
4: syc_Uint32_t policy_ind
5: double eval_result,
6: const swm_causet *cause) {
7:
8: int i;
9: char *name = NULL;
10: syc_uint32_t period;
11: swm_app_rule_t *app_rule;
12: swm_policy_t *policy;
13: swm_policy_condition_t *condition;
14: swm_policy_action_t *action;
15:
16: app_rule = &rule_set->rules[rule_ind];
17: policy = &app_rule->policies.policy[policy_ind];
18: action = &policy->action;
19: condition = &policy->condition;
20:
21: /*-- 1. RESOURCE action --*/
22: if (action->type == SWM_POLICY_RESOURCE) {
23: /*-- Is the default/reference RESOURCE being reinstated?
--*/
24: if (action->action.resource.type ==
SWM_POLICY_RESOURCE_DEFAULT) {
25: for (i = 0; i < app_rule->resource_rules.nrules; i++)
26: if (app_rule->resource_rules.rule[i].resource ==
27: action->action.resource.resource_rule.resource &&
28: app_rule->resource_rules.rule[i].index ==
29: action->action. resource.resource_rule.index){
30: swm_apps_adjust_resou rce_rules(app_id,
action->action.resource.type,
31: &app_rule-> resource_rules. rule[i],
32: condition->check ==
33: SWM_POLICY_CHECK_ON_SET,
34: action- >action.resource.nservers,
35: cause);
36: break;
37: }
38: }
39:
40: /*-- Otherwise, the current RESOURCE is being adjusted --*/
41: else {
42: name = lswm_makeJua_name(rule_ind, policy_ind, 0);
43: if (name) {
44: double resource_pool_value;
45: sychron_evaLtransition_t trans_result = no_evaluation;
46: const char *result = NULL;
47:
48: period = policy->eval_period ?
49: policy->eval_period :
SWM_VARIABLES_BUILT_IN_DEFAULT_PERIOD;
50:
51: /*-- 1a. evaluate RESOURCE expression --*/
52: result = sychron_eval_function(lua_state, name,
app_id,
53: period, 0, ‘“’,
54: SYCHRON_EVAL_FLAGS_NONE,
55: &resource_pool_value,&trans_result);
56: if (result) {
57: /* failed evaluation */
58: slog_msg(SLOG_WARNING, “Error evaluating resource
expression”
59: “[swm_policies_perform_action( ): %s]”
60: “APP ID%d EXPRESSION INDEX %D - no
action taken”,
61: result, (int)app_id, policy_ind);
62: }
63: else {
64: char *tmp_expr;
65: char pool_value[32};
66:
67: /*-- lb. successful evaluation, set new resource value */
68: snprintf(pooLvalue, sizeof(pool_value),
69: “%d”, (int) resource_pool_value);
70:
71: tmp_expr +action-
>action.resource.resource_rule.values.pool;value.amount;
72: action->action.resource.resource_rule.values.pool_value.amount =
73: pool_value;
74:
75: swm_apps_adj ust_resource_ru les(app_id,
action->action.resource.type,
76: &action- >action.resource.resource_rule,
77: condition->check ==
78: SWM_POLICY_CHECK_ON_SET,
79: action->action.resource.nservers,
80: cause);
81:
82: action->action.resource.resource_rule.values.pool_value.
amount =tmp_expr;
83: }
84: }
85: else {
86: slog_msg(SLOG_WARNING, “Error creating resource
expression name”
87: “[lswm_policies_perform_action( )] “
88: “APP ID %d EXPRESSION INDEX %d - no action taken”,
89: (int)app_id, policy_ind);
90: }
91: /* free memory allocated for name */
92: free(name);
93: }
94: }
95:
96: /*-- 2. SCRIPT ACTION --*/
97: else if (action->type == SWM_POLICY_SCRIPT) {
98: name = lswm_make_lua_name(rule_ind, policy_ind,0);
99: lswm_policies_script_action(app_id,
100: name,
101: app_rule,
102: policy,
103: eval_result);
104: free(name);
105: }
106:
107: /*-- 3. LB ACTION --* /
108: else if (action->type == SWM_POLICY_LB) {
109: /* adjust lb-params and the weight of the lb-params
current device * /
110: swm_apps_adjust_lb_rules(app_id,
111: action->action.lb.type,
112: crt.lb.method.name,
113: &action->action.lb.lb_params);
114: }
115:
116: return;
117:
118: }
119: /*&* \end{code}

The policy conditions are evaluated whenever a new variable is set, or the timer expires. When a policy action needs to be performed the above function is called. As shown, a check is first made at line 22 to determine if the action type is a RESOURCE action policy (“SWM_POLICY_RESOURCE”). At line 24 a check is made to determine if the reference (default) allocation of resources is being reinstated. Otherwise, the else condition at line 41 applies and the resource allocation is adjusted.

If the action type is not a RESOURCE action, a check is made at line 97 to determine if the action is to trigger a script (e.g., “SWM_POLICY_SCRIPT”). If so, the steps necessary in order to trigger the script are initiated. If the action type is a load balancer change, then the condition at line 108 applies and the load balancer adjustment is initiated.

While the invention is described in some detail with specific reference to a single-preferred embodiment and certain alternatives, there is no intent to limit the invention to that particular embodiment or those specific alternatives. For instance, those skilled in the art will appreciate that modifications may be made to the preferred embodiment without departing from the teachings of the present invention.

1. A method for providing a system for allocating resources of a plurality of computers to a plurality of applications running in a multiprocessor environment, the system comprising a plurality of computers, each of the plurality of computers executing a policy engine distributed across the plurality of servers, the method comprising:
receiving, by the policy engine at each computer, user input specifying a dynamically configurable policy for allocating resources of the plurality of computers amongst a plurality of applications having access to the resources;
at each of the plurality of computers, detecting, by the policy engine, demands for the resources from the plurality of applications and availability of the resources;
exchanging, by the policy engine at each of the computers, information regarding demand for the resources and availability of the resources amongst the plurality of computers; and
allocating, by the policy engine, the resources to each of the plurality of applications based on the dynamically configurable policy and the information regarding demand for the resources and availability of the resources.

2. The method of claim 1, wherein the resources include one or more of communication resources, processing resources, memory, disk space, system I/O (input/output), printers, tape drivers, load balancers, and software licenses.

3. The method of claim 1, wherein said detecting step includes detecting applications running on each of said plurality of computers.

4. The method of claim 1, wherein said receiving step includes receiving user input specifying actions to be taken for allocation of the resources in response to particular conditions.

5. The method of claim 1, wherein said receiving step includes receiving user input specifying priorities of the plurality of applications to the resources.

6. The method of claim 5, wherein the allocating step includes allocating resources amongst the plurality of applications based, at least in part, upon the specified priorities.

7. The method of claim 1, wherein the receiving step includes providing an expression language for policy definition.

8. The method of claim 1, wherein said detecting step includes determining resource utilization at the given computer.

9. The method of claim 1, wherein said allocating step includes allocating a specified amount of resources to a particular application when the particular application is initially detected at a given computer.

10. The method of claim 1, wherein said allocating step includes communicating with an external module for allocating resources provided by an external module.

11. The method of claim 1, wherein said allocating step includes starting an instance of an application on a given computer.

12. A system, comprising a plurality of computers communicatively connected over a network, wherein each computer comprises a processor and a computer-readable medium, wherein each of the plurality of computers comprises processor executable instructions that, when executed, perform the steps of:
receiving user input specifying a dynamically configurable policy for allocating resources of a plurality of computers amongst a plurality of applications having access to the resources;
detecting demands for the resources from the plurality of applications and availability of the resources;
exchanging information regarding demand for the resources and availability of the resources amongst the plurality of computers; and
allocating the resources to each of the plurality of applications based on the dynamically configurable policy and the information regarding demand for the resources and availability of the resources.

13. The system of claim 12, wherein the resources include one or more of communication resources, processing resources, memory, disk space, system I/O (input/output), printers, tape drivers, load balancers, and software licenses.

14. The system of claim 12, wherein the allocating step includes allocating resources amongst the plurality of applications based, at least in part, upon the specified priorities.

15. The system of claim 12, wherein said allocating step includes allocating a specified amount of resources to a particular application when the particular application is initially detected at a given computer.

16. A computer-readable medium having a software program containing a set of instructions for executing by a system of a plurality of communicatively connected computers, wherein each computer comprises a processor for executing the set of instructions, wherein the set of instructions comprises:
an instruction to receive input from a user specifying a dynamically configurable policy for allocating resources of a plurality of computers amongst a plurality of applications having access to the resources;
an instruction for detecting demands, at each of the plurality of computers, for the resources from the plurality of applications and availability of the resources;
an instruction for exchanging information regarding demand for the resources and availability of the resources amongst the plurality of computers; and
an instruction for allocating the resources to each of the plurality of applications based on the dynamically configurable policy and the information regarding demand for the resources and availability of the resources.

17. The software program of claim 16, wherein the resources include one or more of communication resources, processing resources, memory, disk space, system I/O (input/output), printers, tape drivers, load balancers, and software licenses.

18. The software program of claim 16, wherein the allocating step includes allocating resources amongst the plurality of applications based, at least in part, upon the specified priorities.

19. The software program of claim 16, wherein said allocating step includes allocating a specified amount of resources to a particular application when the particular application is initially detected at a given computer.

20. The software program of claim 16, wherein said allocating step includes starting an instance of an application on a given computer.
